(19) United States
(12) Patent Application Publication
(10) Pub. No.: US 2026/0351439 A1
(43) Pub. Date: Nov. 5, 2026

(54) METHOD OF TRAPPING AND RECONFIGURING CHARGED PARTICLES FOR PERFORMING QUANTUM OPERATIONS AND ELECTRIC FIELD SENSING

(71) Applicant: ETH ZURICH, Zurich (CH)

(72) Inventors: Jonathan HOME, Ebmatingen (CH); Daniel Kienzler, Zürich (CH); Shreyans JAIN, Zürich (CH); Pavel HRMO, Zürich (CH); Tobias SÄGESSER, Zürich (CH)

(73) Assignee: ETH ZURICH, Zürich (CH)

(21) Appl. No.: 19/125,370

(22) PCT Filed: Oct. 25, 2023
(86) PCT No.: PCT/EP2023/079802

§ 371 Date: Apr. 29, 2025

(30) Foreign Application Priority Data
Nov. 1, 2022 (EP) 22204857.1

(51) Int. Cl. G21K 1/20

(52) U.S. Cl. CPC G21K 1/20

(57) ABSTRACT

A method of trapping and reconfiguring at least one charged particle (1) in a trapping apparatus (2) having at least one trapping unit cell (3) is provided. The trapping unit cell (3) has at least one trapping control layer (4) having a trapping surface (5) and at least two electrodes (6, 6a). The method includes the steps of trapping at least one charged particle (1) on a trapping site (7) being generated above the trapping surface (5), cooling the motional modes of the at least one charged particle (1) by coupling its magnetron motional mode to at least one of the other motional modes while simultaneously irradiating electromagnetic radiation onto the charged particle, and reconfiguring a spatial position of the trapping site (7) by applying a time-varying voltage to the electrodes (6, 6a).

### TECHNICAL FIELD

The present invention relates to a method of trapping and reconfiguring at least one charged particle in a trapping apparatus as claimed in claim 1.

### PRIOR ART

Methods of trapping charged particles find various applications, such as electric and magnetic field sensing or the physical realization of quantum operations and quantum information processing to name just a few.

Common trapping apparatuses in this regard are the so-called Penning trap and the Paul trap or radiofrequency trap. The Penning trap differs from the Paul trap in that it uses static electric and magnetic fields to trap charged particles while the latter uses a combination of static and oscillating electric fields.

Surfaces of materials are poorly understood but play an important role in their interactions with other systems. One possibility for discovering more about them is to perform sensitive measurements of charges moving on the surface, but this requires an extremely sensitive electric field sensor.

A promising method for electric field sensing is to use individual atomic ions trapped by both static and radio-frequency fields. The atoms are extremely light, and thus small electric fields can impact them strongly. On the other hand, they can be interrogated using light, allowing information to be extracted. This leads to some of the highest available force sensitivities which can be achieved. However the signal to noise ratio is limited by noise processes on the surface of the trapping structure, while the use of radio-frequency fields to trap ions presents a number of problems with placing structures which might produce interesting fields near the ion. For instance, capacitive coupling from the ion trap to the test structure can create instabilities which lead to the loss of the ion itself, negating its use as a sensor. The signal to noise ratio is also negatively affected by the non-zero temperature of the trapped ion. Consequently, effective cooling of the sensing ion to the lowest possible temperature is desirable.

Quantum computers will utilize the logical rules of quantum mechanics to perform fundamentally more powerful computing than any classical computer. A leading approach in current devices are atomic ions trapped electrically, with the internal states manipulated by microwave and laser fields. Ions interact when close to each other via the Coulomb interaction, which allows logical operations to be performed between information stored in each ion. The fidelity of these logical operation is also severely affected by the non-zero temperature of the trapped ion, thus reinforcing the need for efficient cooling of the ions.

The primary means of trapping ions for quantum computers traps the ions using a combination of radio-frequency and static electric fields. These are known as radio-frequency Paul traps mentioned earlier. To get a high Coulomb interaction, two or more ions are trapped in the same potential well, and gates are then performed between the ions using lasers or microwaves. This control is well established, having been worked on throughout 30 years.

The main challenge for ion trap quantum computers is scaling-current estimates indicate that around 1 million ions will be required for a quantum computer, whereas the largest systems today consist of around 20. For ions, one of two prominent approaches to scaling is called the Quantum CCD architecture, first suggested in the NIST group. It involves a chip scale structure which has many sites between which ions can be shuttled by changing the voltages of the trap in time. Each time that gates need to be performed between two ions they are brought into a common potential well and then pulses of radiation induce the correct coupling. The chip has dedicated regions for ion storage (memory), and operations, controlled by microwaves and laser fields. A major difficulty of this approach, particularly with regards to scalability, is again the radio-frequency field used for trapping, which requires radio-frequency voltages of around 100V to be permanently applied to around half of the electrodes. This heats the chip up and is technically difficult to deliver to the chip without introducing noise. As chips get larger these difficulties will increase due to higher capacitance. It also significantly constrains the transport of ions on chip, requiring special “junction” regions for changing from linear transport to turning left or right. This places severe geometric restrictions which will limit the speed of this approach. A further limitation is the need for two species of ions (either atomic or another isotope) for crosstalk-free cooling of the motion of the ions (used for gates) without disturbing the precious stored quantum information.

Previous works with radio-frequency traps led to the problems mentioned above. Previous published work with Penning traps has used millimeter-scale electrode structures. At NIST large crystals of (>100) ions are trapped in a single potential, which then results in rotation of the 100 ions around the magnetic field and thus to a considerable challenge to performing quantum computing.

Prior work in Penning traps at Imperial College performed non-adiabatic transport of large clouds of ions in millimeter-size Penning traps (non microfabricated and non planar-chip, but made using two PCBs facing each other) using “cycloid shuttles” (D. R. Crick et al, 2010, Rev. Sci. Inst. 81, 013111) as well as cooling of strings of ions aligned in the same potential well along the magnetic field axis. However, the researchers did not spot that ions could be moved perpendicular to the magnetic field by adiabatic transport, which relaxes the constraints on timing of voltage changes considerably, and allows control through purely analog waveforms. Moreover, 25% of ions are lost per transport. Although they speculate on using Penning traps in a similar way to RF traps, they note that no-one has trapped in micrometer scale Penning traps.

Hellwig et al. (M. Hellwig et al., 2010, New. J. Phys. 12, 065019) discuss the use of planar Penning traps for quantum simulation purposes, wherein hexagonal electrodes and adiabatic transport are considered as required for reconfiguring ions slowly from a single deep loading potential to an array of single ions at single sites. Crucially, they fail to describe how their ‘axialization’ leads to resonant motional mode coupling which enables the magnetron motion of a charged particle to be laser cooled. Their axialization acts as an excitation of an ion that moves it to the center and does not describe how low final temperatures of the magnetron mode will be reached. Furthermore, the required segmentation to apply axialization to multiple sites in the array is not discussed at all, meaning the scheme would not be viable for quantum computing due to the prohibitively low fidelities incurred by the high temperature of the ions.

In the context of electron Penning traps, it has been suggested to realize separate trapping potentials with coupled motion, but these do not allow gates by laser fields, or laser cooling because electrons have no optical transitions without the presence of the atomic nucleus.

Jain et al. (S. Jain et al. 2020, Physical Review X 10, 031027) proposes the use of static ions in a microfabricated Penning trap array for quantum simulation and computation. However, transport between different regions as a key component was not considered.

As such, the prior art is associated with many drawbacks such as elaborate chip manufacture, complexity of operating chips, power dissipation on the chip and thus low number of trapping sites, etc.

### SUMMARY OF THE INVENTION

It is an object of the present invention to provide a method of trapping and reconfiguring at least one charged particles in a trapping apparatus that allows the trapping of the charged particle at an individual trapping site and an individual reconfiguration of the trapping site with great flexibility.

This object is achieved with the method of claim 1. That is, a method of trapping and reconfiguring at least one charged particle in a trapping apparatus is provided. The trapping apparatus comprises at least one trapping unit cell defining an extension direction and at least one magnet that is configured to generate a magnetic field. The trapping unit cell comprises at least one trapping control layer. The trapping control layer defines a trapping surface and comprises at least two electrodes. The method comprises the steps of trapping at least one charged particle in the trapping apparatus by generating a magnetic field with the magnet and by generating a static electric potential with the electrodes by applying static voltages to said electrodes, whereby the at least one charged particle is trapped on a trapping site being generated above the trapping surface of the trapping control layer and exhibits motional modes, one of the motional modes being the magnetron motional mode. The method further comprises the steps of i) cooling the motional modes of the at least one charged particle by coupling its magnetron motional mode to at least one of the other motional modes, preferably by applying an axialization voltage to at least one electrode of the trapping control layer, while simultaneously irradiating electromagnetic radiation onto the charged particle, and ii) reconfiguring a spatial position of the trapping site by applying a time-varying voltage to the electrodes, whereby the at least one charged particle is moved along at least one spatial direction.

That is, the application of suitable static voltages to the electrodes generates a static electric potential, i.e. a trapping potential, that in conjunction with a magnetic field traps the charged particle in any three orthogonal spatial directions at the trapping site, i.e. at a point above the trapping surface of the trapping control layer. The trapping apparatus can thus be said to define at least one trapping site where the charged particle is trapped. In particular, the static voltages being applied to the at least two electrodes are preferably such that a quadrupolar potential generating a quadratic well in the axial direction and a quadratic hill in a radial direction is generated. In other words, the static voltages being applied to the at least two electrodes preferably generate a static electric quadrupolar potential that together with the magnetic field traps the charged particle at the zero of the electric field.

The static electric potential created by the at least two electrodes in combination with the magnetic field results in harmonic motion of the charged particle around the trapping site. In this configuration of static electric and magnetic fields, three oscillations at their respective frequencies occur, which are referred to as axial (with the strongest alignment to the magnetic field direction), modified cyclotron, and magnetron oscillations as used commonly in prior art. The radial motion of the charged particle comprises the modified cyclotron motion and the magnetron motion. To this end it is preferred that the magnetic field is aligned to an axial direction of the trapping apparatus. Various orientations of the axial direction with respect to the trapping surface of the trapping control layer are conceivable. That is, the orientation of the axial direction can be arbitrary. However, it is preferred that the orientation of the axial direction extends parallel to the trapping surface of the trapping control layer and thus perpendicular to the extension direction of the trapping unit cell. The radial motion is preferably in a plane given by the two directions perpendicular to the axial direction. That is, the trapping unit cell when being embedded in a magnetic field can be seen as a so-called Penning trap. In other words, the charged particle being trapped in the trapping apparatus can be said to exhibit motional modes that are induced by the static electric field and the magnetic field, one of the motional modes being the magnetron motional mode. The other motional modes preferably are the axial motional mode and the modified cyclotron motional mode.

In the present application, the motional modes are also referred to as modes of motion. In particular, the magnetron motional mode is also referred to as magnetron mode or magnetron mode of motion. The modified cyclotron motional mode is also referred to as cyclotron motional mode. The axial mode of motion is also referred to as axial mode.

Hence, the motional modes of the charged particle are preferably cooled by coupling the magnetron motional mode to the axial motional mode or the modified cyclotron motional mode of the charged particle. To this end it is particularly preferred to apply an axialization voltage to the at least one electrode of the trapping control layer while simultaneously irradiating electromagnetic radiation onto the charged particle. The axialization voltage preferably is a time-varying voltage and/or a radio-frequency-voltage that generates an axialization potential, see also further below.

The motional modes of the charged particle being cooled means that the motional amplitude of said modes of the charged particle is reduced. After this cooling, second stage cooling methods become viable (see below).

The magnetron motional mode being coupled to at least one of the other motional mode means that the amplitudes of the motion are periodically exchanged between these two modes.

In order to cool the charged particles by irradiating electromagnetic radiation it is preferred that the trapping apparatus comprises at least one source of electromagnetic radiation being configured to emit electromagnetic radiation, in particular a laser, see also further below.

The cooling of the charged particle using electromagnetic radiation in the presence of the axialization potential preferably forms a first stage of cooling following which a second step (see below) can be used to bring at least one of the modes of the charged particle to or near its motional ground state. Near the motional ground state means that the ground state is occupied with a probability of at least 50% or more. This is a necessary pre-requisite for high-fidelity quantum operations such as quantum computation, and for high sensitivity electric-field sensing. In particular, quantum operations involving two charged particles require both to be in or near their motional ground state in their individual trap sites thus requiring the ability to generate axialization potentials at each trapping site at which a charged particle is present.

Furthermore, time-varying voltages are applied to the electrodes. As a consequence, a time-varying electric potential is generated, which reconfigures or moves the spatial position of the trapping site, and hence the spatial position of the charged particle being trapped on the trapping site along at least one spatial direction and preferably along all three spatial directions. Applying a time-varying voltage to the electrodes changes the trapping potential, in particular the location of the produced trapping site in space. At each point in time the charged particle remains trapped at the trapping site defined by the electric potential in that moment of time. Consequently, tailoring the landscape of the electric potential that traps the charged particle gives rise to a flexible configuration of one or more trapping sites holding at least one charged particle each. In other words, by applying appropriate voltages to one or more electrodes a location of the trapping sites along at least one spatial direction and in particular along all three spatial directions can be moved. Thus, the trapping unit cell allows a 3-dimensional transport of the at least one trapped charged particle.

Said time-varying voltage is preferably varied arbitrarily so as to generate arbitrary changes of the electric potential in time. However, and as has been mentioned earlier and as will be explained in greater detail further below, it is additionally conceivable that said time-varying voltage is oscillating at a fixed frequency in order to generate oscillatory changes of the electric potential applied at a fixed frequency. For the sake of simplicity, the former is referred to as the ‘time-varying voltage’ and the latter as the ‘axialization voltage’, see above and below.

The static electric potential is preferably generated by applying a static voltage to the electrode being in the range of tens of volt (V) and/or being between −100 V and 100 V. However, the exact voltage applied to each electrode is preferably determined by the dimensions and arrangement of the electrodes and the desired electric potential at the trapping site.

The time-varying voltages preferably vary within a range of about −100 V to 100 V and/or on timescales ranging from about 1 microsecond to 1 second. It is furthermore preferred to vary the voltages according to one or more predefined sequences that enable the reconfigurability of the trapping apparatus including but not limited to a translation of the trapping site along the trapping unit cell such that the charged particle remains trapped at its trapping site.

The voltages being applied to the electrodes can be varied on timescales much slower than the motional frequency of the charged particle to facilitate transport of the charged particle to various locations above the trapping surface and/or change the oscillation frequency of the trapped charged particle.

In other words, the voltages can be varied adiabatically or non-adiabatically. That is, the voltage being applied to one or more of the electrodes can be varied adiabatically, i.e. slowly, for instance within 10 microsecond or more, such as within 10 microsecond and 1 second. In this case the charged particle can follow the position of the trapping potential and travel from a starting point to an end point while keeping its motional quantum state. However, it is likewise conceivable to vary the voltage non-adiabatically, for instance within less than 10 microseconds, if care is taken to preserve the motional state of the charged particle by suitable acceleration/deceleration processes.

The voltages being applied to the electrodes are preferably such that the charged particle is trapped at a distance of 1 micrometer to 200 micrometers, more preferably at a distance of 10 micrometers to 100 micrometers above the trapping surface with respect to a direction running parallel to the extension direction of the trapping unit cell. Furthermore, the voltages being applied to the electrodes are preferably such that the electric potential trapping the charged particle leads to motional frequencies of the charged particle at a trap frequency in the range of 10 KHz to 100 MHz.

The trapping apparatus preferably comprises one or several voltage sources that are configured to generate and preferably furthermore time-control the voltages being applied to the electrodes of the trapping unit cell.

The magnet is preferably configured to generate a strong static magnetic field such as a magnetic field having a magnetic field strength in the range of 0.1 Tesla to 100 Tesla, preferably 1 Tesla to 10 Tesla. However, other magnetic field strengths are likewise conceivable.

Various orientations of the magnetic field with respect to the trapping surface of the trapping control layer are conceivable. That is, the orientation of the magnetic field can be arbitrary. However, it is preferred that the orientation of the magnetic field with respect to the trapping surface is in-plane or out-of-plane. Particularly preferably, the magnetic field is configured to trap the charged particle in a radial plane, wherein said radial plane is perpendicular to the direction of the magnetic field and wherein the magnetic field is aligned to the axial direction.

The magnet can be a superconducting magnet or a singularity or plurality of permanent magnets. Furthermore, exactly one magnet or two or more magnets such as an array of magnets are conceivable.

The trapping control layer preferably is an outermost layer of the trapping unit cell. The trapping control layer preferably comprises or consists of one or more electrically conducting materials and particularly preferably is provided by one or more electrodes. It is conceivable that one or more of these electrodes are additionally made out of an electrically conducting and also transparent material, see further below.

A preferred dimension of the electrode(s) along the extension direction is in the range of nanometers to tens of micrometers, for instance between 10 nanometers to 100 micrometers preferably between 500 nanometers to 10 micrometers, and along the transverse directions extending perpendicularly to the extension direction is in the range of tens of micrometers, for instance between 1 micrometer to 1000 micrometers, preferably between 10 micrometers to 100 micrometers. The two transverse direction dimensions need not be equal.

At this point it should be noted that the trapping unit cell can comprise two or more trapping control layers. In this case it is preferred that one of the trapping control layers provides a top layer of the trapping unit cell and the other of the trapping control layers provides a bottom layer of the trapping unit cell. That is, the trapping unit cell can be configured to trap and reconfigure charged particles on both of its sides.

Various types of charged particles can be trapped and reconfigured in the method according to the invention. For instance, the charged particles can be atomic ions or molecular ions.

To this end it is conceivable that exactly one, i.e. a single, charged particle is trapped on the single trapping site. Alternatively, two or more charged particles can be trapped on a single trapping site.

The trapping control layer can comprise a plurality of electrodes and wherein a plurality of trapping sites are generated, and wherein the spatial positions of the plurality of trapping sites are independently reconfigured by applying the time-varying voltages to the plurality of electrodes.

In other words, the trapping control layer preferably comprises a plurality of electrodes, and wherein two or more of the electrodes receive the static voltage. Furthermore, any or all of these electrodes can also receive a time-varying voltage. If the trapping unit cell comprises a plurality of electrodes, suitable voltages may be applied to generate more than one trapping site above the trapping surface.

The electrodes of the trapping control layer are preferably arranged adjacent to one another with respect to the transverse direction. Said electrodes can be of various shapes such as of a planar shape and/or a rectangular shape. The shape of the individual electrodes can be the same or different from one another. For instance, all electrodes can be of a first shape such as a rectangular shape having a length and the electrodes to which the axialization voltage is applied can be of a second shape being different from the first shape such as a rectangular shape having a length being longer than the length of the electrodes. Additionally or alternatively, the shapes within the sets of electrodes, i.e. the shapes of the individual electrodes and/or the shapes of the individual electrodes to which the axialization voltage is applied, can vary.

It is particularly preferred that the electrodes of the trapping control layer are arranged as a two-dimensional array and/or as a tiling array. The exact layout of the electrodes is flexible and can be tailored for the designated use-case of the trapping unit cell.

The trapping apparatus can comprise exactly one trapping unit cell or two or more trapping unit cells. In the latter case, it is preferred that the trapping unit cells are arranged as a two-dimensional array and/or as a tiling array. The tiling array can be an arbitrary 2-dimensional arrangement of the trapping unit cells, with a simple instance being a square grid. The different trapping unit cells can be assigned different functions, for example, initial trapping of a charged particle, as well as gate operations, readout etc., as will be explained in greater detail below. If two or more trapping unit cells are present, they can have a same structure such as identical electrodes and layers or a different structure.

Hence, one trapping unit cell can provide one or more trapping sites such as two trapping sites. Each trapping site can trap one or more charged particles. Furthermore, the trapping apparatus can comprise one or more trapping unit cells. Explanations made herein regarding one trapping unit cell and/or one trapping site preferably likewise apply to the situation where two or more trapping unit cells and/or two or more trapping sites are present and vice versa.

The charged particle is preferably cooled at a plurality of trapping sites by coupling its magnetron motional mode to at least one of the other motional modes, preferably by applying a plurality of axialization voltages to a plurality of electrodes of the trapping control layer, while simultaneously irradiating electromagnetic radiation onto the charged particle.

At least two charged particles are preferably trapped on at least two trapping sites. The reconfiguration of the spatial positions of the at least two trapping sites preferably comprises an axial merging and/or axial splitting and/or a radial merging and/or radial splitting of the at least two trapping sites. Additionally or alternatively, the charged particles are preferably simultaneously cooled at each trapping sites by coupling their magnetron motional modes to at least one of their other modes, preferably by applying axialization voltages independently to the electrodes of the trapping control layer, while simultaneously irradiating electromagnetic radiation onto the charged particles before and/or after the reconfiguration of the spatial position of the trapping sites.

This approach opens up new possibilities to initialize cold, 2-dimensional arrays of trapped charged particles for the purposes of quantum computation or correlated electric field noise sensing.

The trapping unit cell can comprise at least one current-carrying conductor and wherein the method comprises the step of controlling the charged particle by supplying a static or oscillating current to the current-carrying conductor in order to create a static magnetic field gradient in the magnetic field and/or an oscillating magnetic field gradient. Additionally or alternatively, the method can comprise the step of controlling the charged particle by irradiating electromagnetic radiation onto the charged particle.

The charged particle being controlled preferably corresponds to a manipulation of one or more internal states of the charged particle and/or of one or more external states of the charged particles.

An internal state of the charged particle could be a quantum information state such as an electronic state of the charged particle. As an example, the charged particle could be controlled by irradiating electromagnetic radiation onto the charged particle in order to excite the charged particle into a particular electronic state. As another example, the charged particle could be controlled by supplying the oscillating current to the current-carrying conductor in order to generate an oscillating magnetic field gradient that excites an atomic transition within the charged particle.

An external state of the charged particle can be a motional state of the charged particle and/or its rotational or vibrational state. As an example, the charged particle could be controlled by supplying an oscillating current to the current-carrying conductor in order to create an oscillating magnetic field gradient in order to excite a vibrational state of the charged particle.

The oscillating current preferably has an oscillation frequency in the microwave range. That is, the current-carrying conductor is preferably configured to supply oscillating current having an oscillation frequency in the microwave range of the electromagnetic spectrum.

The current-carrying conductor can be provided in the trapping control layer. Additionally or alternatively, the trapping unit cell can comprise at least one microwave control layer, and wherein the current-carrying conductor is provided in the microwave control layer, i.e. at least one current-carrying conductor can be provided in one or more other layers of the trapping unit cell.

That is, the trapping unit cell can comprise two or more layers that are preferably arranged above one another, i.e. stacked, with respect to the extension direction. In this case it is preferred to arrange at least one substrate layer between each two such layers that electrically isolates these layers from one another, see also further below.

For example, the trapping unit cell can comprise at least one microwave control layer, and wherein at least one current-carrying conductor is arranged in said microwave control layer.

The microwave control layer preferably comprises or consists of materials which have high conductivity and low noise and loss at the operating frequency, such as gold.

A thickness of the microwave control layer with respect to the extension direction preferably is between 10 nanometers and 100 micrometers, more preferably between 200 nanometers and 800 nanometers such as about 500 nanometers.

It is furthermore preferred that the trapping apparatus comprises at least one microwave signal generator for generating an oscillating current having an oscillation frequency in the microwave range and being in connection with the at least one current-carrying conductor.

The trapping unit cell preferably comprises at least one optical control layer being configured to direct electromagnetic radiation towards the charged particle, and wherein the method comprises the step of optically controlling the charged particle by irradiating electromagnetic radiation onto the charged particle via the optical control layer.

The optical control of the charged particle preferably corresponds to a manipulation of one or more internal states of the charged particle and/or one or more external states of the charged particle as mentioned earlier however through the use of electromagnetic radiation with a frequency lying in the optical range of the electromagnetic spectrum. Furthermore, controlling the charged particle may additionally comprise methods of laser cooling such as Doppler cooling, sideband cooling and so on.

The optical control layer preferably comprises at least one waveguide being configured to guide electromagnetic radiation and at least one grating coupler being configured to couple electromagnetic radiation into or out of the waveguide. Said waveguide and grating coupler are preferably configured to route electromagnetic radiation from a source of electromagnetic radiation towards the charged particle and/or to collect and route electromagnetic radiation being emitted from the charged particle towards a detection device.

The waveguide preferably is an optical waveguide that is configured to guide electromagnetic waves in the optical spectrum. The waveguide preferably is made of transparent dielectric materials such as silicon nitride or alumina, as is typical in the art. It is furthermore preferred that the waveguide is embedded within the optical control layer. Further, the bulk of the optical control layer preferably comprises or consists of a dielectric material such as silicon dioxide, which preferably serves as the cladding of the optical waveguides.

A thickness of the optical control layer with respect to the extension direction preferably is between 50 nanometers and 100 micrometers, more preferably between 100 nanometers and 50 micrometers such as about 10 micrometers.

The grating coupler preferably is configured to couple electromagnetic radiation into or out of the waveguide and is a so-called grating out-coupler or a grating in-coupler as it is known in the art. Moreover, the grating coupler is preferably connected to the waveguide and arranged such as to irradiate the charged particle with the electromagnetic radiation guided in the waveguide. Transparent areas are introduced in the layers between the grating coupler and the trapping surface, such as to allow optical access of the electromagnetic radiation to the trapped charged particle. For example, transparent electrodes can be introduced in the trapping control layer, such as electrodes made of ITO (indium tin oxide).

To this end it is conceivable that the waveguide and grating coupler serve the purpose of routing electromagnetic radiation from a source of electromagnetic radiation such as a laser towards the charged particle in order to excite the charged particle into a particular internal state. Additionally or alternatively, the waveguide and grating coupler can serve the purpose of collecting and routing electromagnetic radiation being emitted from the charged particle towards a detection device. For example, after the charged particle is excited by the electromagnetic radiation the charged particle can decay while emitting one or more photons which are preferably collected and thereafter routed to a detection device, see also further below.

The trapping apparatus preferably comprises at least one detection device, and wherein the method comprises the step of detecting a presence or absence of the charged particle and/or at least one internal state of the charged particle and/or at least one external state of the charged particle with the detection device preferably by detecting electromagnetic radiation being emitted from the charged particle.

The detection device is preferably configured to detect electromagnetic radiation being emitted by the charged particle. As such, a presence of the charged particle in the trapping apparatus can be determined. Additionally or alternatively, the internal and/or external state(s) of the charged particle can be read out.

Moreover, the detection device is preferably configured to convert a photonic signal into an electrical signal. That is, the collection of the electromagnetic radiation being emitted by the charged particle is preferably followed by a conversion of the photonic signal to an electrical signal which is further routed to a counting device or the like which then reads out the internal and/or external state the charged particle is in.

Additionally or alternatively, a presence or absence of the charged particle can be detected. For instance, the charged particle could be configured to undergo a spontaneous decay from a short-lived atomic state, whereby it emits a photon. The source of electromagnetic radiation such as the laser can be used to excite the charged particle to this atomic state repeatedly and hence force it to emit many photons, which can be used as a signal to ascertain the quantum information state. The presence/absence of this emitted radiation is the quantity that enables the state discrimination.

However, it should be noted that various detection devices are conceivable, wherein further examples of a conceivable detection device are a camera, a photomultiplier tube, a superconducting nanowire detector, etc. For instance, in the event that the charged particles have been excited into an electronic state, the following decay to the ground state emits a photon which can be detected with a camera. Detection devices with high spatial and temporal resolution like a fast camera allow for a site-resolved state detection of the charged particles, especially in the case of a large number of charged particles, for instance.

The detection device can be at least partially a part of the trapping unit cell. However, it is likewise conceivable that the detection device is not part of the trapping unit cell but arranged elsewhere in the trapping apparatus. An example of a detection device being at least partially a part of the trapping unit cell could be a superconducting nanowire detector that forms part of the optical control layer.

The detection device can comprise further components participating in the detection of electromagnetic radiation being emitted by the charged particle, such as an objective lens being arranged in the trapping apparatus such as to focus the emitted electromagnetic radiation onto the camera or photomultiplier tube or the like.

As explained in greater detail below, said detection with the detection device preferably corresponds to a readout, in particular to a so-called readout of the quantum information state of the charged particles.

The trapping apparatus preferably comprises at least one source of electromagnetic radiation such as a laser, and wherein the method comprises the step of irradiating electromagnetic radiation in order to:
ionize at least one particle in order to generate the charged particle, and/or
cool the charged particle, such as to reduce a motional amplitude of at least one motional mode of the charged particle preferably to or near to the motional ground state, and/or
prepare the charged particle in a desired quantum state, such as an internal state of the charged particle and/or an external state of the charged particle.

That is, and as has been mentioned earlier, the trapping apparatus preferably comprises at least one source of electromagnetic radiation being configured to emit electromagnetic radiation, in particular a laser.

Said electromagnetic radiation can serve various purposes. For instance, it can be used to generate charged particles such as ions, e.g. a laser can be used for photoionization.

Additionally or alternatively, it can be used to prepare such as excite the charged particles into a particular quantum state. As will be explained in greater detail below, said preparation preferably corresponds to a so-called quantum information state initialization.

Additionally or alternatively, the source of electromagnetic radiation in conjunction with the detection device can be used to detect a presence of the charged particle and/or at least one internal state and/or at least one external state of the charged particle as mentioned earlier.

Additionally or alternatively, it can be used for cooling, in particular laser cooling, the modes of motion of the charged particle. To this end it is preferred to perform two or more steps of cooling the charged particle. In a first step, it is preferred to Doppler cool the charged particle. In a subsequent second step it is preferred to perform a subsequent cooling of the charged particle to or near its motional quantum ground state on one or more of its modes of motion, said subsequent cooling preferably being performed by electromagnetically induced transparency cooling, polarization-gradient cooling or sideband cooling, as they are known in the art.

The wavelength(s) of the source(s) of electromagnetic radiation such as the laser(s) is preferably determined by the (one or more) species of charged particles trapped within the trapping apparatus.

The method preferably comprises the step of applying an axialization voltage to at least one electrode of the trapping control layer in order to generate an axialization potential that facilitates cooling of the magnetron mode of the charged particle by coupling it to at least one other mode of motion.

That is, the motion of the charged particle is cooled by irradiating the charged particle with electromagnetic radiation, in particular with laser radiation in order to laser cool the charged particles, wherein cooling of the magnetron mode in particular is preferably facilitated by applying an axialization potential to at least one electrode at the same time as the charged particle is irradiated.

The axialization potential preferably is an oscillating quadrupole potential being generated by applying voltages in the range of 0.1 millivolts to 100 millivolts in amplitude and oscillating at frequencies in the range of 0.01 MHz to 100 MHz such as in the range of 0.1 MHz to 10 MHz to one or more electrodes. That is, the axialization potential particularly preferably is a quadrupolar potential oscillating in the radio-frequency (RF) domain. The exact RF frequency depends on the motional frequency of the two motional modes that are coupled together as described above. The electric field of the axialization potential should preferably vanish at each location of a trapping site to facilitate cooling of all motional modes of the charged particles and avoid micromotion. Micromotion is undesirable as it negatively affects the fidelity of the quantum computation and the sensitivity of the electric field sensing.

The axialization potential facilitates the cooling of the magnetron motion of the charged particle. As it is well-known in the art, the magnetron mode of motion is preferably cooled by coupling this motional mode to at least one of the other motional modes and using a conventional method such as Doppler laser cooling to cool the other mode. Said coupling is achieved by preferably driving an electrode at a frequency equal to the sum of the frequencies of the magnetron mode and the mode to which it is coupled. That is, the magnetron motional mode is preferably resonantly coupled to at least one of the other motional modes. For instance, it is preferred to Doppler cool all the motional modes of the charged particle by irradiating laser radiation of an appropriate wavelength, which is determined by the atomic properties of the chosen charged particle, and by simultaneously applying the axialization potential to the charged particle, whereby the magnetron motional mode is coupled to at least another motional mode. However, in the art so far, the axialization potential was only ever applied to one trapping site where the site can coincide with the vanishing electric field of the axialization and not to a reconfigurable trap site position along a plurality of vanishing electric field locations. Furthermore, the axialization potential was never applied to a plurality of trapping sites, where the electric field vanishes at all the sites.

This technique, known as axialization in the art, is preferably performed during Doppler cooling of the charged particle and/or during quantum state readout of the charged particle, see further below. This cooling can be seen as a first stage cooling. As mentioned earlier, it is conceivable to perform a second stage cooling that follows said first stage cooling. That is, a second stage cooling can be performed in order to cool the charged particles to or near their motional ground state. Possible methods for the second stage cooling are electromagnetically-induced transparency (EIT) cooling, polarisation-gradient cooling and sideband cooling as they are known in the art.

Hence, and as an example, the charged particles could be initially Doppler cooled under axialization and subsequently sideband cooled to or near their quantum ground state for all three modes of motion.

Thus, the trapping unit cell according to the invention, in particular the trapping control layer, is preferably configured to create at least one trapping site where the charged particle is trapped and is additionally preferably configured to assist with the cooling of the charged particle, through the aforementioned axialization technique.

It should again be noted that the axialization potential can be generated by applying the appropriate RF potential to one or more electrodes of the trapping control layer. Any statements regarding one of these electrodes likewise apply to several of these electrodes and vice versa.

The trapping unit cell preferably comprises:
at least one interconnect layer comprising at least one electrically conducting track that is in connection with the electrodes, and/or
at least one ground plane layer being held at electrical ground and being configured to electrically shield the electrodes, and/or
at least one substrate layer being configured to electrically isolate conducting layers of the trapping unit cell from each other.

That is, the trapping unit cell preferably comprises at least one interconnect layer comprising at least one electrically conducting track that is in connection with the electrode(s) on the trapping control layer. In this case the method preferably comprises the step of routing the static voltage and the time-varying voltage to the electrodes and, if applicable, the axialization voltage to said electrically conducting track.

The interconnect layer preferably routes the voltages from the outside of the trapping control layer to the different electrodes of the trapping chip and also allows for possible co-wiring of electrodes and/or current-carrying conductors mentioned earlier. The electrically conducting tracks on the interconnect layer are preferably connected to the electrodes of the trapping unit cell through vias as they are known in the art.

Additionally or alternatively, the trapping control layer and/or the interconnect layer preferably further comprise at least one transparent electrode being optically transparent to electromagnetic radiation being directed from the optical control layer towards the charged particle and/or being emitted from the charged particle and being collected within the optical control layer. A conceivable material for said transparent electrodes is indium tin oxide, as has been demonstrated in the art.

One or more transparent areas can be provided in one or more further layers of the trapping unit cell such as in the microwave control layer and/or in further layers such as a ground plane layer, see below. If transparent areas are provided in different layers of the trapping unit cell, it is preferred that these transparent areas are at least partially arranged congruent with respect to the extension direction and in particular with respect to a direction formed between the trapping site and the grating in-coupler and/or out-coupler. In other words, two or more transparent areas and/or electrodes are preferably at least partially overlapping with respect to the direction between the source and destination of the electromagnetic radiation, which could interchangeably be the trapped charged particle or the grating(s).

The trapping unit cell preferably further comprises at least one substrate layer being arranged between the trapping control layer and the interconnect layer when seen along the extension direction. The substrate layer is configured to electrically isolate the conducting areas of the layers from each other, except for the vias electrically connecting the interconnect layer to other layers. Any statements regarding one of these layers likewise apply to several of these layers and vice versa.

The substrate layer preferably comprises or consists of a dielectric material, such as silicon dioxide or sapphire, as is typical in the art.

A thickness of the substrate layer with respect to the extension direction preferably is between 100 nanometers and 100 micrometers, more preferably between 500 nanometers and 50 micrometers such as between 1 micrometer and 10 micrometers.

The trapping unit cell preferably comprises at least one ground plane layer being electrically conducting and being held at electrical ground and/or that is configured to electrically shield the electrodes.

That is, the ground plane layer serves the purpose of electrically shielding the other electrically conductive components of the trapping unit cell from one another. For instance, the ground plane layer preferably electrically shields the electrodes of the trapping control layer from underlying conducting layers such as the interconnect layer and/or the microwave control layer and vice-versa.

The ground plane layer is preferably arranged between the trapping control layer and the interconnect layer with respect to the extension direction.

A thickness of the ground plane layer with respect to the extension direction preferably is between 10 nanometers and 100 micrometers, more preferably between 100 nanometers and 1000 nanometers such as about 500 nanometers.

The ground plane layer preferably comprises or consists of one or more electrically conducting materials such as those considered for the electrodes, in particular, gold, copper and niobium.

Hence, the trapping unit cell preferably comprises several layers that are arranged above one another along the extension direction. In other words, the trapping unit cell preferably comprises a stack of layers. Furthermore, two or more of any particular layer can be provided. For instance, the trapping unit cell can comprise preferably in this sequence along the extension direction:
a trapping control layer,
a substrate layer,
a ground plane layer,
a substrate layer,
an interconnect layer,
a substrate layer,
a microwave control layer,
a substrate layer,
an optical control layer, and
a substrate layer.

That is, it is preferred that a substrate layer is arranged between each electrically conductive layer when seen along the extension direction.

A thickness of the trapping unit cell along the extension direction preferably is in the range of one to several hundred micrometers. Additionally or alternatively, a width of the trapping unit cell along the transverse direction preferably is in the range of one to thousands of micrometers, such as between 10 micrometers and 100 micrometers.

The trapping unit cell is preferably manufactured according to microfabrication techniques such as complementary metal-oxide-semiconductor (CMOS)-based layer stack-up as they are known in the art.

The trapping apparatus preferably comprises at least one source for generating particles or charged particles and/or at least one vacuum chamber, wherein the trapping unit cell is received in the vacuum chamber.

A conceivable source for generating particles involves the creation of neutral particles via an effusive oven or ablation, wherein said neutral particles are subsequently ionized for instance with the source of electromagnetic radiation such as the laser mentioned earlier or by bombardment with charged particles such as electrons.

That is, the trapping of the charged particle can involve an initial step of loading the trapping unit cell, wherein suitable charged particles are produced at the trapping sites, preferably supplied from a flux of neutral particles which are ionized preferably by laser irradiation or by bombardment of the neutral particles with additional charged particles, preferably electrons. The neutral particle flux is preferably produced either through heating up a solid material which effuses, or preferably by ablating neutral particles from a solid using electromagnetic radiation. However, it is likewise conceivable that said source is configured to directly generate charged particles.

The trapping apparatus preferably comprises a vacuum chamber, and wherein at least the trapping unit cell, but possibly also one or more further components of the trapping apparatus, are arranged in the vacuum chamber. A high-vacuum environment allows for retention of charged particles by minimizing particle-loss through background-gas collisions. A pressure in the vacuum chamber preferably is 10\hat{ }(−9) mbar or less.

In the event of the trapping unit cell being arranged in the vacuum chamber various ways for the electromagnetic radiation to access the trapping unit cell exist. For example, in the event that the trapping unit cell comprises one or more waveguides, the electromagnetic radiation could enter the vacuum chamber via optical fibers or the like that are attached to the trapping unit cell to deliver the electromagnetic radiation to the waveguides.

In the absence of waveguides, the electromagnetic radiation can be directed into the vacuum chamber and onto the (charged) particles through a path of free optical access.

It should be noted that there can be a number of beams of electromagnetic radiation, in particular laser beams, per (charged) particle.

In a first aspect, the trapping apparatus is preferably configured as a quantum information processor, and wherein the charged particle being trapped in the trapping apparatus is reconfigured to perform at least one quantum operation such as quantum computation. The quantum operation is preferably performed by:
(1) trapping at least one charged particle on at least one trapping site by applying the magnetic field and the static voltages to the electrodes,
(2) cooling the charged particle preferably by irradiating electromagnetic radiation onto the charged particle and by applying an axialization voltage to the electrodes,
(3) performing a quantum information state initialization by controlling the charged particle, preferably by irradiating electromagnetic radiation onto the charged particle, whereby the charged particle is initialized,
(4) reconfiguring a spatial position of the at least one trapping site by applying the time-varying voltages to the electrodes, whereby the initialized charged particle is moved along at least one spatial direction to a desired location above the trapping surface of the trapping control layer,
(5) performing at least one quantum logic gate operation preferably by irradiating the charged particle with electromagnetic radiation, and
(6) performing a quantum state readout preferably by detecting the presence or absence of the charged particle and/or at least one internal state of the charged particle and/or at least one external state of the charged particle with the detection device.

That is, the trapping apparatus according to the invention can be used for temporally and spatially configuring and re-configuring the internal (electronic) and external (motional and positional) states of the charged particle. To this end it is preferred that at least one, two or more charged particles are trapped in the trapping apparatus as described above.

Hence, the trapping unit cell according to the invention can be used in a quantum information processor.

In this case it is preferred that the trapping apparatus provides at least two trapping sites. Said two trapping sites can be provided on a single trapping unit cell or on two or more trapping unit cells. Said two or more trapping unit cells are preferably arranged as a two-dimensional array and/or as a tiling array as described earlier.

In any case it is preferred that the trapping unit cell(s) of the trapping apparatus is loaded with at least two charged particles and the motion of the charged particles is cooled by irradiating electromagnetic radiation such as laser radiation and by generating the axialization potential. This cooling corresponds to the first stage cooling mentioned earlier.

To this end it is preferred to use the source for generating charged particles until a sufficient number of charged particles is loaded.

Said loading can occur until a subset of the available trapping sites being provided by the trapping apparatus are populated. Reloading to repopulate sites from which charged particles are lost is anticipated.

This can be followed up by reconfiguring the charged particles into a desired array or the like by applying the time-varying voltages to the electrodes, whereby the charged particles are moved in space to the desired trapping sites. As such, some trapping sites can be operated as dedicated loading zones or reservoirs. The source for generating charged particles can be focused only on those trapping sites, and wherein after an initial trapping and cooling of the charged particles the charged particles can be transported to the desired trapping site. This step can be repeated a number of times until a desired array of charged particles has been assembled.

To this end it is conceivable to vary the trapping voltage adiabatically, i.e. slowly, for instance the trapping voltage can be varied within 10 microsecond or more, such as within 10 microsecond and 1 second. In this case the charged particle can follow the position of the trapping potential and travel from a starting point to an end point while keeping its motional quantum state.

However, it is likewise conceivable to vary the trapping voltage non-adiabatically, for instance within less than 10 microseconds. In this case, the charged particle can be accelerated and then decelerated while keeping its cooled state.

In a following step it is preferred to apply a second stage of cooling wherein the charged particle is cooled to or near its motional quantum ground state in one or more modes of motion. This can be achieved by, for example, sideband cooling whereby a judiciously selected set of electromagnetic radiation fields is tuned precisely in frequency such that the quantum motional state is reduced at the single quantum excitation level. The frequency selectivity of this approach allows one mode to be cooled independently without significantly affecting the others. Subsequent application to the other modes allows all of them to be cooled to or near the motional quantum ground state. Other alternative techniques such as electromagnetically induced transparency or polarization gradient cooling can be used to achieve similar results.

Cooling of the trapped charged particles reduces the kinetic energy of oscillations of the charged particle position around the trapping site as explained earlier.

In a subsequent step it is preferred to perform a so-called quantum information state initialization, wherein the charged particle is prepared in a desired internal or external state. For instance, the initialization of the electronic state of the charged particle, such as an alkaline earth metal atomic ion, can be performed by incoherent optical pumping being mediated through appropriately chosen laser radiation. Said quantum information state initialization can be understood as a preparation of the state of the charged particle, within the subspace that allows quantum information to be encoded, and said state could be an internal electronic state or an appropriate state composed of the motional states of the trapped charged particle.

Once the quantum information state initialization has been performed, the charged particle can be moved to a desired location above the trapping surface of the trapping unit cell(s) by applying appropriate time-varying voltages to the electrode(s). To this end it is preferred to move the charged particle primarily in a plane parallel to the surface of the trapping unit cell, in particular parallel to the surface of the electrodes of the trapping control layer. However, it is likewise conceivable to move the charged particle normal to this plane. The movement of the charged particle is preferably based on a desired sequence of quantum logic gate operations to be performed.

For example, if a gate operation shall be performed on quantum information states encoded using two charged particles, it is preferred to move the two charged particles close together so as to enhance their mutual interaction through the Coulomb force as will be described later, and to thereafter move the two charged particles apart in order to perform a quantum information state readout.

As mentioned earlier, the variation of the voltage applied to the electrode(s) allows the generation of a trapping potential at different coordinates relative to a center of the trapping unit cell. For instance, sets of voltages can be applied to the electrode(s) that allow for a number of intermediate positions between starting and final coordinates in all three spatial directions, wherein said sets are preferably applied in sequence. If applied slowly, i.e. adiabatically, for instance within a time of 10 microseconds to 1 second, the charged particle will follow the position of the trapping potential and travel from the starting to the final coordinate, while keeping the low motional excitation it had after the cooling step.

However, the voltages being applied to the electrode(s) can also be varied non-adiabatically, for instance within less than 10 microseconds.

Furthermore, in the event that the trapping apparatus comprises two (or more) trapping unit cells, it is conceivable that voltages are applied to the electrodes of said two trapping unit cells in order to transport the charged ion from one trapping unit cell to the other trapping unit cell.

In fact, the trapping unit cell according to the invention enables a movement of at least one charged particle parallel as well as perpendicular to the magnetic field, or any other direction relative to the magnetic field alignment.

At this point it is preferred to perform at least one quantum logic gate operation on either a single charged particle or on multiple charged particles. Said quantum logic gate operation is preferably performed by irradiating the charged particle with electromagnetic radiation such as laser radiation and/or microwave radiation. In the event that two or more charged particles are trapped said charged particles share motional states because of a Coulomb repulsion, and wherein this collective motion effectively forms a bus for sharing information stored in a quantum state such as the electronic states of the ions. The strength of the motional coupling increases as the charged particles are brought closer together. As such, it is preferred to move the charged particles close to one another in order to increase the speed of the quantum gate operation between them.

After the quantum gate operation has been performed it is preferred to perform a quantum information state readout with the detection device as mentioned earlier. For example, a discrimination between two internal states of a charged atomic ion can be carried out by collecting state-dependent fluorescence emitted from the ion via the detection device. By counting the number of photons detected via for instance a photomultiplier device one can distinguish which of the two internal states the ion is in.

Steps (1) to (6) can be performed in the given ordering. However, the steps can also be performed in a different ordering, for instance, the charged particles could be cooled prior to the initialization of the quantum information states.

It is preferred that several quantum logic gate operations are performed, and wherein a position of the charged particle is reconfigured after one or more quantum logic gate operations.

That is, when the trapping apparatus is used for performing a quantum operation it is preferred that the method comprises the execution of several quantum logic gate operations, and wherein a spatial position of the trapping site(s) is preferably reconfigured after one or more quantum logic gate operations by applying the time-varying voltage to the electrode so as to move the charged particles. That is, the quantum logic gate operations are preferably interspersed with a movement or transport of the relevant charged particle as a way to enable the execution of the desired quantum operation such as a quantum computational task.

It is furthermore preferred that at least two charged particles are trapped on at least two trapping sites, and wherein the reconfiguration of the spatial positions of the at least two trapping sites comprises a so-called axial merging and/or axial splitting and/or a radial merging and/or radial splitting of the at least two trapping sites.

That is, the present invention allows axial merging and axial splitting of charged particles in different trapping sites, and wherein the charged particles being trapped in individual trapping sites are moved together and away from one another by varying the voltage being applied to the electrodes appropriately. Another example of reconfiguring charged particles is a radial merging and radial splitting of the charged particles in different trapping sites, wherein the charged particles are moved along one of the radial directions.

Hence, if the charged particles shall interact with one another, for instance for performing quantum logic gate operations, at least two trapping sites each with one or more charged particles can be brought close to each other and the quantum logic gate operation can be performed using the resulting coupled motion as for charged particles being stored in a single potential well. Thereafter, the trapping sites can again be separated from one another.

A possible sequence of steps in order to perform a quantum operation preferably is as follows:
0. Load a single charged particle into individual trapping sites of one or more trapping unit cells (i.e. one charged particle per trapping site)
1. Cool the charged particles
2. Initialize quantum information states
3. Perform a quantum logic gate operation (via laser(s) and/or microwave)
4. Reconfigure positions of charged particles
5. Perform another quantum logic gate operation (via laser(s) and/or microwave)
6. Reconfigure positions of charged particles
7. Read out quantum information states for instance by detecting a subset of charged particles.

Steps 2 through 7 are preferably repeated a plurality of times so as to perform a quantum computation.

Another possible sequence of steps in order to perform a quantum operation preferably is as follows:
0. Load two or more charged particles into one or more trapping sites of one or more trapping unit cells
1. Cool the charged particles
2. Initialize quantum information states
3. Perform a quantum logic gate operation (via laser(s) and/or microwave)
4. Reconfigure positions of charged particles
5. Perform another quantum logic gate operation (via laser(s) and/or microwave)
6. Reconfigure positions of charged particles
7. Read out quantum information states for instance by detecting a subset of charged particles.

Steps 2 through 7 are preferably repeated a plurality of times so as to perform a quantum computation.

That is, the trapping apparatus according to the invention can provide a tiling structure of trapping unit cells to hold and spatially reconfigure charged particles such as ions, cool the motional modes, perform quantum logic gate operations, and detect quantum information states, and as such provides a new architecture for trapped-ion quantum computation.

In a second aspect, the trapping apparatus is preferably configured as an electric field sensor, and wherein the charged particle being trapped in the trapping apparatus is reconfigured to perform electric field sensing. The electric field sensing is preferably performed by probing a sample surface by measuring the electric field noise experienced by the charged particle due to the presence of the sample surface.

That is, the trapping apparatus according to the invention can be used for electric field sensing. In other words, the trapping apparatus preferably is an electric field sensor or is part of an electric field sensor and is configured to sense electric fields. Consequently, the trapping unit cell according to the invention can be used in an electric field sensor.

To this end it is preferred that the trapping apparatus comprises a single trapping unit cell that traps a single charged particle. However, two or more trapping unit cells, or a single trapping unit cell trapping two or more charged particles could likewise be provided, for instance if the surface shall be probed with differential spatial sensitivity.

The electrodes of the trapping control layer are preferably surrounded by a ground plane in the same layer. However, it is likewise conceivable that the trapping unit cell comprises one or more of the further layers such as the interconnect layer, the microwave control layer, etc.

The sample surface to be probed can be a separate surface that is not part of the trapping unit cell, i.e. that is an external or separate surface. However, it is likewise conceivable that the sample surface to be probed forms part of the trapping unit cells, in particular of the trapping surface of the trapping control layer.

The motion of the charged particle is susceptible to electric field noise at all its motional frequencies. Such electric field noise could emanate from the electrodes and/or other nearby surfaces, such as the surface to be probed in the event of said surface being a separate surface. Changing the motional frequencies of the charged particle by changing the trapping voltage being applied to the electrode, makes the charged particle more or less susceptible to the electric field noise in the spectral range where the motional frequencies lie. These motional frequencies can be varied from 10 s of kHz to 10 s of MHz.

As will be explained below, movement of the trapping site with respect to the sample surface provides spatial resolution of the electric field noise. For instance, by moving the charged particle normal to the sample surface to be probed assists in mapping out electric field noise as a function of the distance from the ‘noisy’ sample surface. By using the fact that the radial and axial modes of motion are preferably orthogonal to each other, electric field noise along two geometrical axes can be probed independently and/or simultaneously.

The measuring of the electric field noise preferably comprises the steps of:
(1) trapping at least one charged particle on at least one trapping site by applying the magnetic field and the electrical voltage to the electrodes,
(2) cooling the charged particle preferably by irradiating electromagnetic radiation onto the charged particle and by applying an axialization voltage to the electrodes,
(3) performing a quantum information state initialization by controlling the charged particle, preferably by irradiating electromagnetic radiation onto the charged particle, whereby the charged particle is initialized,
(4) reconfiguring a spatial position of the at least one trapping site by applying the time-varying voltages to the electrodes, whereby the initialized charged particle is moved along at least one spatial direction to a desired location above the trapping surface of the trapping control layer,
(5) allowing the charged particle to interact with a noise source affecting an internal or external state of the charged particle,
(6) performing at least one quantum logic gate operation preferably by irradiating the charged particle with electromagnetic radiation, and
(7) performing a quantum state readout preferably by detecting the presence or absence of the charged particle and/or at least one internal state and/or at least one external state of the charged particle with the detection device.

Hence, the electric field sensing can be performed in a manner being very similar or identical to the quantum operations.

Preferred differences between the two applications are the following.

Compared to the trapping apparatus being used for performing quantum operations the trapping apparatus being used as an electric field sensor preferably differs in that a single charged particle is loaded at a single trapping site.

Furthermore, it is preferred that the quantum logic gate comprise gates acting on single trapped particles and not gates acting on multiple trapped particles. That is, operations can be fewer and simpler.

Moreover, the quantum logic gate operations could be performed by free-space laser beams and microwave radiation, respectively, which can be guided across the trapping surface of the trapping control layer towards the charged particle. In other words, components such as the microwave control layer and/or the optical control layer in the trapping unit cell can be dispensed with. That is, the trapping unit cell being used in the trapping apparatus in the form of the electric field sensor can be of a simpler design.

A possible sequence of steps in order to perform an electric field sensing preferably is as follows:
0. Load at least one charged particle into a single trapping site of a single trapping unit cell
1. Cool the charged particle
2. Initialize the quantum information state
3. Reconfigure position of charged particle
4. Interaction of the charged particle with the noise source
5. Quantum logic operation via a laser and/or microwave
6. Readout of the potentially altered quantum information states.

Hence, in summary it can be said the trapping apparatus according to the invention can be used as a quantum information processor for performing quantum operations and as an electric field sensor for sensing electric fields both being based on the trapping and active spatial reconfiguration of one or more such as an array of charged particles above at least one trapping unit cell, and wherein the charged particles are trapped by a combination of static electric and magnetic fields with dynamic changes to the electric field used for reconfiguring the charged particle locations.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows an exploded view of a trapping unit cell according to the invention;

FIG. 2 shows a sectional view of the trapping unit cell according to FIG. 1;

FIG. 3 shows a perspective view of the trapping unit cell according to FIG. 1, wherein a charged particle is trapped and will be reconfigured for performing quantum operations;

FIG. 4 shows a perspective view of a two-dimensional array of trapping unit cells according to FIG. 1, wherein charged particles are trapped and will be reconfigured for performing quantum operations;

FIG. 5 shows another perspective view of a trapping unit cell, wherein a charged particle is trapped and will be reconfigured for electric field sensing;

FIG. 6 shows perspective views of an array of two trapping unit cells according to FIG. 5, wherein the charged particles are reconfigured so as to perform an axial merging and splitting;

FIG. 7 shows perspective views of an array of two trapping unit cells according to FIG. 5, wherein the charged particles are reconfigured so as to perform a radial merging and splitting;

FIG. 8 shows a perspective view of an array of two trapping unit cells according to FIG. 5, wherein a 2-qubit gate is performed on the charged particles by irradiating electromagnetic radiation emanating from the waveguides in the optical control layer;

FIG. 9 shows a partial exploded view of the trapping unit cell according to FIG. 5, wherein a 2-qubit gate is performed on the charged particles by irradiating microwave radiation;

FIG. 10 illustrates a state-dependent detection of a charged particle being trapped in a trapping unit cell according to FIG. 5 after a quantum gate operation has been performed;

FIG. 11 shows a level scheme of a ⁹Be⁺ ion in a magnetic field of 3 Tesla;

FIG. 12 shows a top view of another trapping unit cell according to the invention in an initial state;

FIG. 13 shows a partial schematics of a trapping apparatus according to the invention;

FIG. 14 shows a schematics of a phase locking in the trapping apparatus of FIG. 13;

FIG. 15 shows a graph depicting the probability of finding the charged particle in a particular quantum information state after applying electromagnetic radiation in the trapping apparatus of FIG. 13;

FIG. 16 shows a pulse sequence being applied to obtain the data depicted in the graph of FIG. 15;

FIG. 17 shows a schematics that depicts a second stage cooling being performed in the trapping apparatus of FIG. 13;

FIG. 18 shows a pulse sequence for a second stage cooling and thermometry being performed in the trapping apparatus of FIG. 13;

FIG. 19a shows a graph depicting the thermal state of the charged particle using the pulse sequence of FIG. 18 at a first point in time;

FIG. 19b shows a graph depicting the thermal state of the charged particle using the pulse sequence of FIG. 18 at a second point in time, leading to a measure of the heating rate;

FIG. 20a shows a top view of another trapping unit cell, wherein a charged particle is trapped;

FIG. 20b shows a diagram depicting voltages to be applied to the trapping unit cell of FIG. 20a in order to reconfigure the trapped particle in an out-of-plane direction;

FIG. 21a shows a top view of an array of three trapping unit cells;

FIG. 21b shows a top view of the array of three trapping unit cells of FIG. 21a, wherein two charged particles are trapped and reconfigured;

FIG. 21c shows a diagram depicting the voltages applied to the left trapping unit cell of FIG. 21a in order to reconfigure the charged particles as depicted in FIG. 21b;

FIG. 21d shows a diagram depicting the voltages applied to the middle trapping unit cell of FIG. 21a in order to reconfigure the charged particles as depicted in FIG. 21b;

FIG. 21e shows a diagram depicting the voltages applied to the right trapping unit cell in order to reconfigure the charged particles as depicted in FIG. 21b;

FIG. 22a shows a top view of another array of three trapping unit cells;

FIG. 22b shows a top view of the array of three trapping unit cells of FIG. 22a, wherein two charged particles are trapped and reconfigured;

FIG. 22c shows a diagram depicting the voltages applied to the left trapping unit cell of FIG. 22a in order to reconfigure the charged particles as depicted in FIG. 22b;

FIG. 22d shows a diagram depicting the voltages applied to the middle trapping unit cell of FIG. 22a in order to reconfigure the charged particles as depicted in FIG. 22b;

FIG. 22e shows a diagram depicting the voltages applied to the right trapping unit cell in order to reconfigure the charged particles as depicted in FIG. 22b.

### DESCRIPTION OF PREFERRED EMBODIMENTS

Various aspects of the method of trapping and reconfiguring one or more charged particles 1, 1a in a trapping apparatus 2 according to the invention shall now be illustrated in greater detail with respect to the figures.

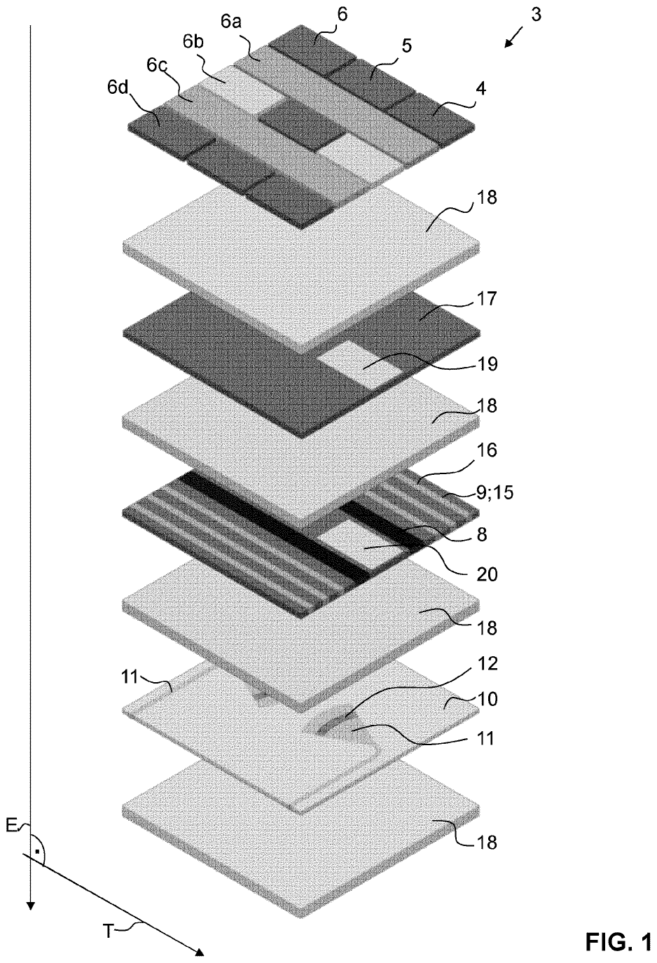

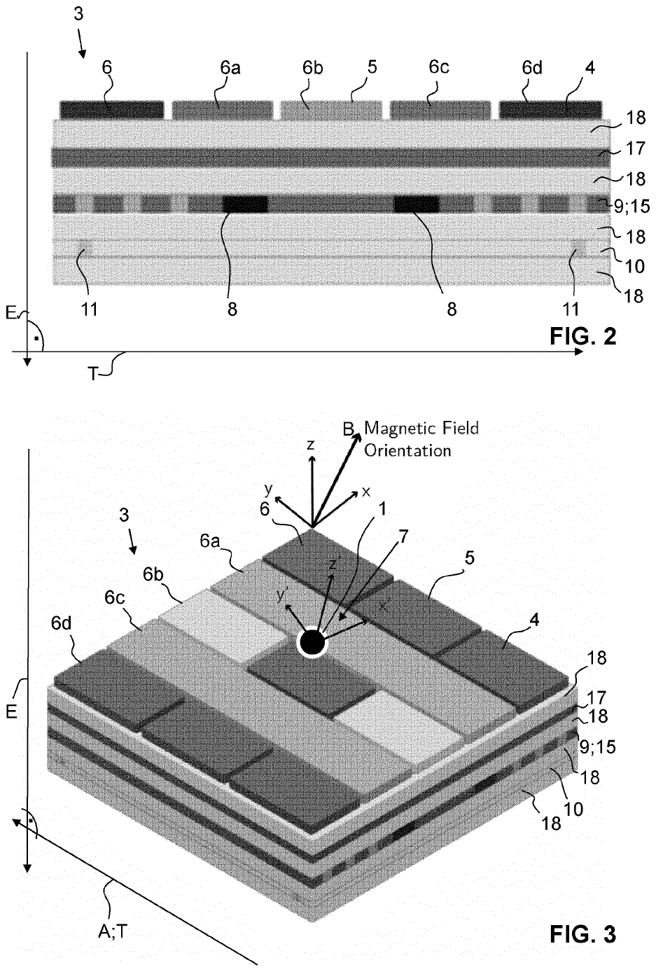

The trapping apparatus 2 comprises in any case at least one trapping unit cell 3 defining an extension direction E and being configured to trap at least one charged particle 1. Furthermore, said trapping unit cell 3 comprises at least one trapping control layer 4 and, as follows from FIGS. 1 to 3, can comprise additional layers. In particular, these figures depict in each case a trapping unit cell 3 comprising several layers that are arranged above one another or stacked with respect to the extension direction E. In fact, in the depicted examples the trapping unit cell 3 comprises in this sequence along the extension direction E:
a trapping control layer 4,
a substrate layer 18,
a ground plane layer 17,
a substrate layer 18,
a microwave control layer 9 comprising an embedded interconnect layer 15,
a substrate layer 18,
an optical control layer 10, and
a substrate layer 18.

The trapping control layer 4 defines a trapping surface 5 and comprises electrodes 6, 6a, 6b, 6c, 6d that can receive a static voltage in order to generate a static electric potential. For the sake of clarity, not all electrodes have been given reference signs in the figures, but only a selection of them. It should be understood that an entire area expansion of the trapping control layer 4 is provided by such electrodes.

As will be outlined in greater detail below, the trapping apparatus 2 further comprises at least one magnet that is configured to generate a magnetic field B. As illustrated in FIG. 3, the application of a magnetic field B together with the static electric potential of the electrodes 6, 6a, . . . traps the charged particles 1 at a point above the trapping surface 5 of the trapping control layer 4. The trapping unit cell 3 can thus be said to define at least one trapping site 7 where the charged particle is trapped. The axial direction A along which the charged particle 1 is trapped preferably extends parallel to the trapping surface 5 of the trapping control layer 4 and thus perpendicular to the extension direction E of the trapping unit cell 3. The charged particle 1 is thus trapped on a trapping site 7 being located at a distance from the trapping surface 5 of the trapping control layer 4 when seen along the extension direction E.

The electrodes 6, 6a, . . . of the trapping control layer 4 can furthermore receive a time-varying voltage, wherein the spatial position of the trapping site 7 trapping the charged particle 1 above the trapping surface 5 of the trapping control layer 4 and consequently its trapped charged particle 1 is moved along one or more spatial directions x, y, z, i.e. within a plane parallel to the trapping surface 5 of the trapping control layer 4 (x-direction and γ-direction in FIG. 3) as well as along a direction running vertically to the trapping surface 5 of the trapping control layer 4 (z-direction in FIG. 3).

One or more electrodes 6, 6a, . . . of the trapping control layer 4 can receive an axialization voltage so as to generate an axialization potential that assists in the cooling of the charged particle 1, see further below.

Moreover, one or more electrodes 6, 6a, . . . of the trapping control layer 4 can be made of an optically transparent material that is optically transparent for electromagnetic radiation being directed from the optical control layer 10 towards the charged particle 1 and being emitted from the charged particle 1 and being collected by the optical control layer 10.

In the depicted examples, electrodes 6, 6a-d are electrodes receiving the static voltage, electrodes 6a and 6c are electrodes additionally receiving the axialization voltage, and electrode 6b is additionally a transparent electrode.

Moreover, as readily follows from these figures, the trapping control layer 4 comprises several electrodes 6, 6a, . . . that are arranged next to one another with respect to transverse directions T running perpendicularly to the extension direction E and that provide the trapping surface 5 above which the charged particles 1, 1a are trapped. As follows from these figures, these electrodes 6, 6a, . . . can be of various shapes such as of a planar shape and/or a rectangular shape, and wherein the shape of certain electrodes differ from one another. Here, these electrodes 6, 6a, . . . are provided as a two-dimensional array, in particular as a tiling array.

The trapping unit cell 3 comprises several substrate layers 18 that are made of a dielectric material and that serve the purpose of electrically insulating the electrically conducting materials of the trapping unit cell 3 from one another such as the conducting electrodes 6, 6a, . . . of the trapping control layer 4 from the ground plane layer 17 or the interconnect layer 15.

The ground plane 17 layer is electrically conducting and is held at electrical ground. It serves the purpose of electrically shielding the electrically conductive components of the trapping unit cell 3 from one another.

As follows from FIG. 1, the ground plane layer 17 comprises a transparent area 19. The transparent area 19 of the ground plane layer 17 is congruent with one of the transparent electrodes of the trapping control layer when seen along to the extension direction E. These transparent electrode and transparent area 19 are furthermore arranged congruent with a transparent area 20 of the microwave control layer 9. This arrangement ensures that outgoing or incoming electromagnetic radiation R can travel through the trapping unit cell 3 from the trapping site 7 of the charged particle 1 to the optical control layer 10 and vice versa.

The interconnect layer 15 comprises several electrically conducting tracks 16 that are in connection with the electrodes 6, 6a, . . . of the trapping control layer 4. The interconnect layer 15 routes voltages from an outside of the trapping control layer 4 to the different electrodes 6, 6a, . . . of the trapping control layer 4 and also allows for possible co-wiring of specific electrodes such as current-carrying conductors 8, see below. The electrically conducting tracks 8 on the interconnect layer 15 are connected to the electrodes 6,6a, . . . of the trapping unit cell 3 through vias (not shown).

The microwave control layer 9 comprises current-carrying conductors 8 that serve the purpose of supplying an oscillating current in order to create an oscillating magnetic field gradient in the magnetic field or of supplying a static current in order to create a static magnetic field gradient in the magnetic field. Said oscillating current preferably has an oscillation frequency in the microwave range. To this end, the trapping apparatus 2 comprises at least one microwave signal generator for generating these oscillating currents and which is in connection with the current-carrying conductors 8 of the microwave control layer 9. In this way a controlling of the charged particle 1, in particular a manipulation of the internal states of the charged particle 1 and/or of the external states of the charged particle 1 can be achieved. For instance, the oscillating current can result in an oscillating magnetic field gradient that excites an atomic transition within the charged particle 1.

The optical control layer 10 is configured to direct electromagnetic radiation R towards the charged particle 1 and allows the optically controlling of the charged particle 1 by irradiating electromagnetic radiation R onto the charged particle 1 via the optical control layer 10. The optically controlling of the charged particle 1 can be seen as a manipulation of the internal states and/or of the external states of the charged particle 1 as it is the case with the oscillating current provided by the microwave control layer 9, however through the use of electromagnetic radiation R with a frequency lying in the optical range of the electromagnetic spectrum. As seen in FIG. 1, the optical control layer 10 comprises two waveguides 11 being configured to guide electromagnetic radiation R and a grating coupler 12 being connected to each waveguide 11 for coupling electromagnetic radiation R into and out of the waveguides 11. However, it should be noted that not all of these layers must be present for the trapping unit cell 3 to trap. For instance, the microwave control layer 9 and/or the optical control layer 10 could be dispensed with, and wherein microwave radiation and/or laser radiation could be irradiated onto the charged particles 1 through a path of free optical access.

The trapping unit cell 3 is manufactured in a CMOS fabrication process as it is known in the art. Consequently, the trapping unit cell 3 is of a small size, in particular of a microsize, wherein a thickness of the trapping unit cell 3 along the extension direction E as well as a width of the unit cell along the transverse directions T is in the range of one to several micrometers. The width along the transverse directions T can also be referred to as the width along the x-direction and the y-direction mentioned earlier. A thickness of the trapping control layer 4 with respect to the extension direction E preferably is between 10 nanometer and 100 micrometers. A thickness of the substrate layer 18 with respect to the extension direction E is between 100 nanometer and 100 micrometers. A thickness of the ground plane layer 17 with respect to the extension direction E preferably is between 10 nanometer and 100 micrometers. A thickness of the microwave control layer 9 with respect to the extension direction E is between 100 nanometers and 100 micrometers. A thickness of the optical control layer 10 with respect to the extension direction E is between 50 nanometers and 50 micrometers. As readily follows from FIGS. 1 to 3, the widths, i.e. extensions along the x-direction and the y-direction or along the transverse directions T, of all layers of the trapping unit cell 3 are the same.

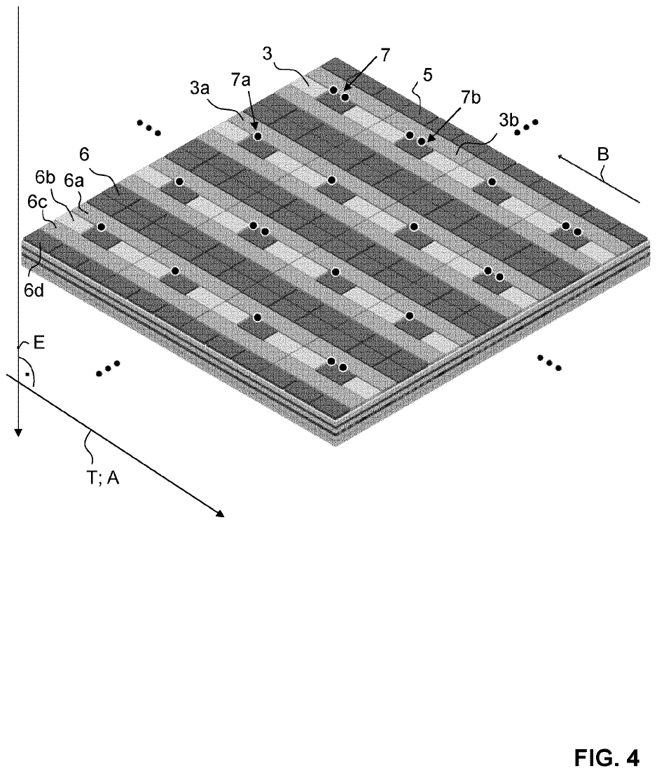

The trapping apparatus 2 can comprise exactly one trapping unit cell 3 or two or more trapping unit cells 3, 3a, . . . . In particular, and as follows from FIG. 4, the trapping apparatus 2 can comprise a plurality of trapping unit cells 3, 3a, 3b, . . . that are preferably arranged as a two-dimensional tiling array that defines a plurality of trapping sites 7, 7a, 7b, . . . .

The different trapping unit cells 3, 3a, 3b, . . . can be assigned different functions, for example, trapping the charged particles 1, 1a, . . . , as well as gate operations, readout etc., allowing the trapping apparatus 2 to make up a quantum information processor or an electric field sensor. Moreover, various orientations of the magnetic field B with respect to the trapping unit cell(s) 3, in particular to the trapping surface(s) 5 of the trapping control layer(s) 4 are conceivable.

For instance, in the example depicted in FIG. 3 the magnetic field B is oriented at an angle to the trapping surface 5 of the trapping control layer 4, and wherein the orientation of the magnetic field B and the principal axes of oscillation x′, y′ and z′ are indicated with respect to the coordinate system of the trapping unit cell 3 being defined here by the three spatial directions x, y, and z or x-direction, y-direction and z-direction, respectively. This trapping unit cell 3 is an example of a trapping unit cell 3 of a quantum information processor.

That is, said trapping unit cell 3 can be part of an array of trapping unit cells 3, 3a, . . . as shown in FIG. 4, wherein several trapping unit cells 3, 3a, . . . are provided in a tiling arrangement. In the depicted example, the magnetic field B is aligned with respect to the trapping surface 5 of the trapping control layer 4, in particular to the electrodes 6, 6a, . . . of the trapping control layer 4 providing said trapping surface 5. The magnetic field B being oriented parallel to the trapping surfaces 5 is aligned to the axial direction A mentioned earlier, wherein the magnetic field B is configured to trap the charged particles 1, 1a, . . . in a radial plane running perpendicularly to the direction of the magnetic field B. The charged particles 1, 1a, . . . can be shuttled across and between the trapping unit cells 3, 3a, . . . without the requirement of junction regions, as are present in r.f. trap based architectures of the prior art. The trapping apparatus 2 comprising said trapping unit cells 3, 3a, . . . can make up a quantum information processor.

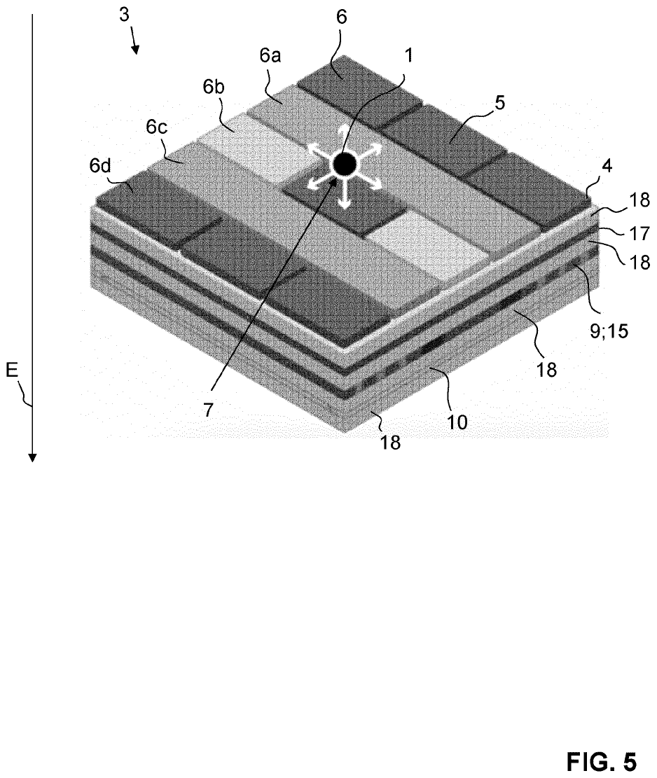

FIGS. 5 to 10 depict examples of the trapping unit cell 3 being used in a trapping apparatus 2 that makes up a quantum information processor or an electric field sensor.

In fact, and as indicated in FIG. 5, the method according to the invention allows a three-dimensional transport of a charged particle 1, wherein the charged particle 1 can be transported in plane, i.e. along the trapping surface 5 of the trapping control layer 4 and/or out of plane, i.e. towards and away from the trapping surface 5 of the trapping control layer 4. Said three-dimensional transport allows for scanning the electric field noise across space.

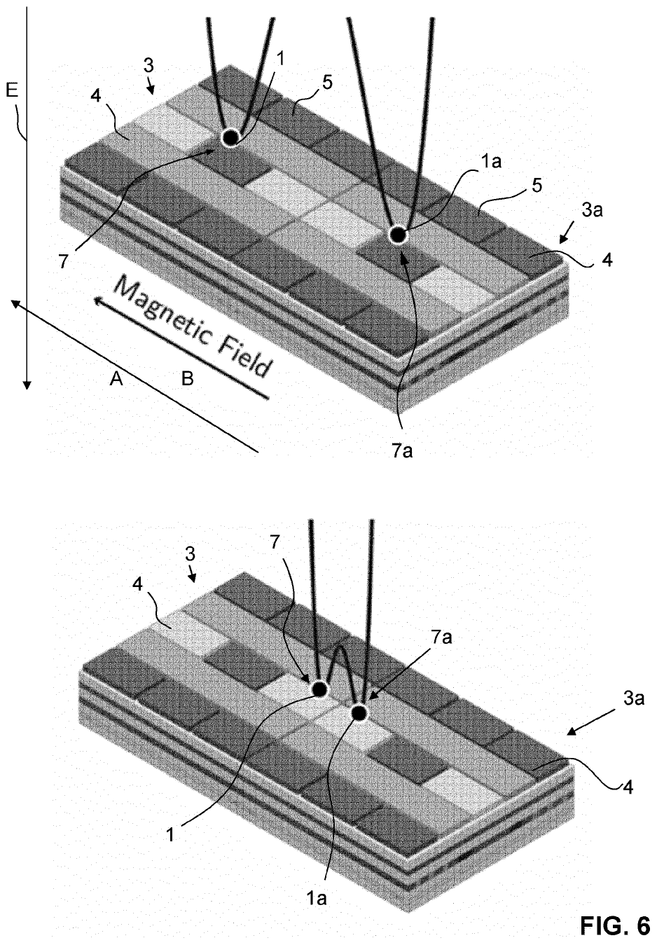

FIG. 6 illustrates the capability of the method according to the invention to perform an axial merging and axial splitting of charged particles 1, 1a in different trapping sites 7, 7a. That is, the trapping apparatus 2 could comprise two adjacent trapping unit cells 3, 3a each trapping one charged particle 1, 1a, and wherein a spatial reconfiguration of the two charged particles 1, 1a is performed. In particular, trapped charged particles 1, 1a sitting in individual trapping sites 7, 7a can be brought together, for instance, to do a two-qubit gate, and can then brought back away from each other afterwards. In the depicted example, shuttling of the charged particles 1, 1a is done along the axial direction A i.e. along the direction of the magnetic field B. The black lines show how the electric potential varies in space along this separation, with the charged particles 1, 1a being trapped at the local minima.

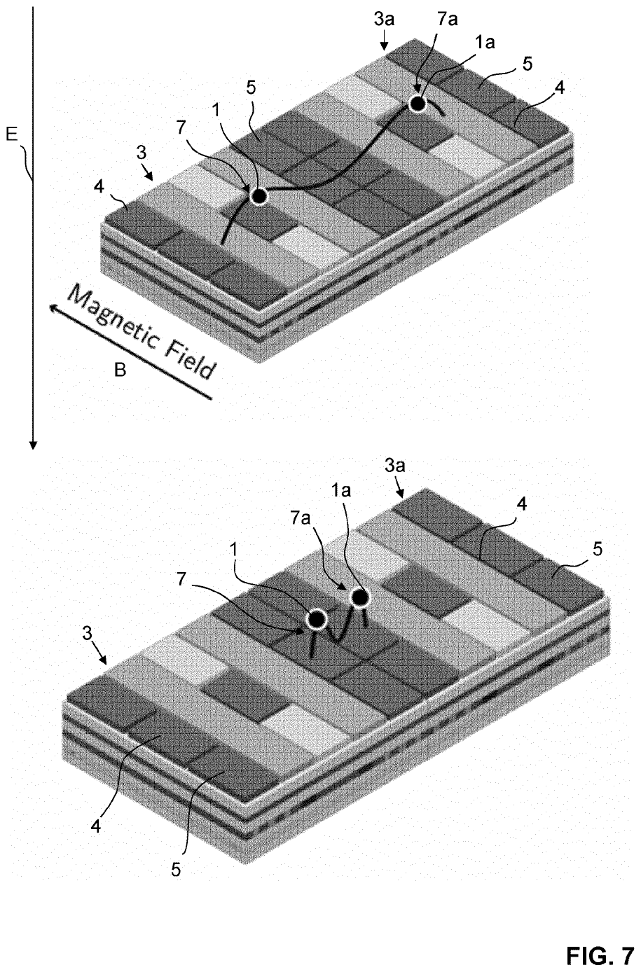

FIG. 7 illustrates the capability of the method according to the invention to perform a radial merging and radial splitting of the charged particles 1, 1a in different trapping sites. That is, a trapping apparatus 2 comprising two adjacent trapping unit cells 3, 3a can be provided, wherein each trapping unit cell 3, 3a traps one charged particle 1, 1a, and wherein a spatial reconfiguration of the two charged particles 1, 1a is performed by shuttling the charged particles 1, 1a along one of the radial directions, i.e. along the normal to the direction of the magnetic field B which runs perpendicular to the extension direction E. The black lines show the variation of the radial electric potential, with the charged particles 1, 1a being trapped at the local maxima.

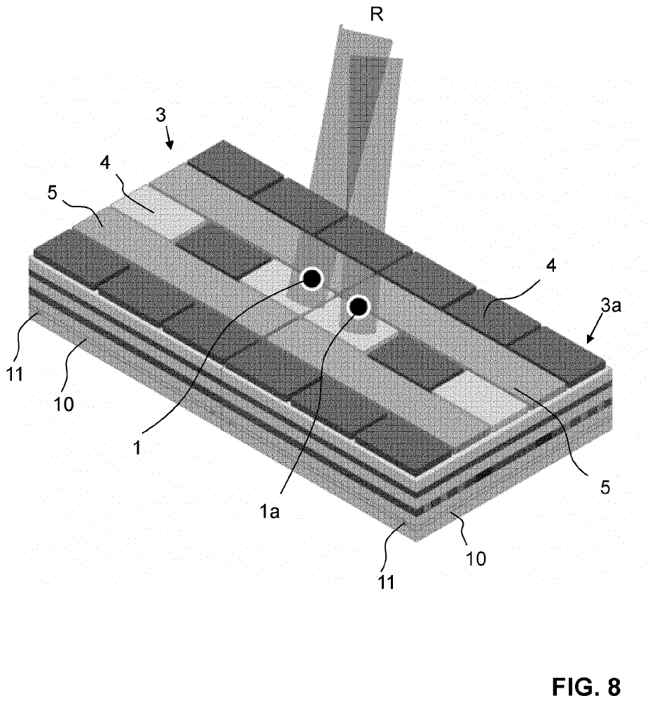

FIG. 8 illustrates the capability of the method according to the invention to perform a 2-qubit gate with laser radiation R. That is, a trapping apparatus 2 comprising two adjacent trapping unit cells 3, 3a can be provided, wherein each trapping unit cell 3, 3a traps one charged particle 1, 1a, and wherein a two-qubit gate is driven by simultaneously addressing both charged particles 1, 1a with laser radiation R, for instance emitted from the grating outcouplers 12 of the optical control layers 10 of the trapping unit cells 3, 3a.

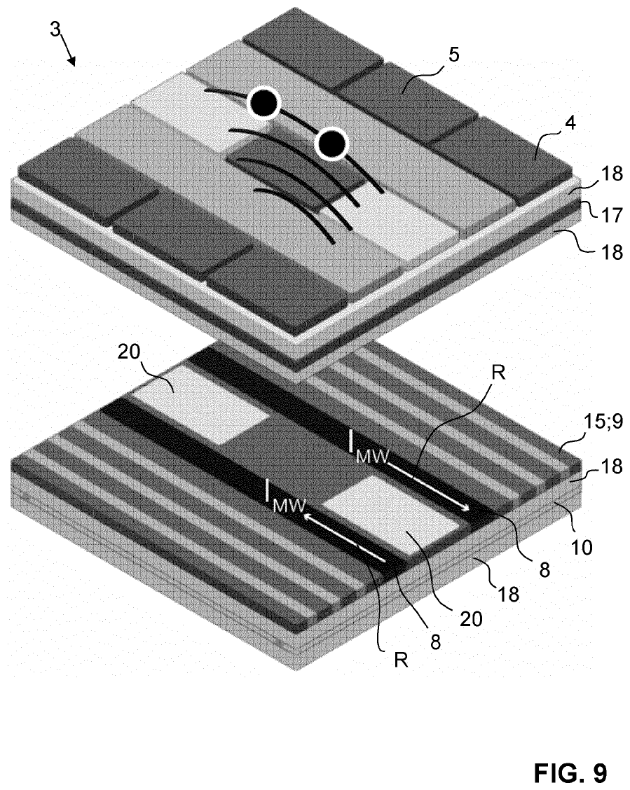

FIG. 9 illustrates the capability of the method according to the invention to perform a 2-qubit gate with microwave radiation R. That is, a trapping apparatus 2 comprising one trapping unit cell 3 can be provided, wherein said trapping unit cell 3 comprises a microwave control layer 9. A two-qubit gate is driven by simultaneously addressing both charged particles with microwave radiation R driven by a current I_{MW} emitted from the current-carrying conductors 8 on the microwave control layer 9.

Although FIGS. 5 to 9 depict one or two trapping unit cells 3, 3a and two charged particles 1, 1a, it goes without saying that these operations can likewise be performed for a different number of trapping unit cells and/or charged particles.

After a quantum gate operation as above has been performed, a quantum state readout or qubit readout with a detection device is preferably performed.

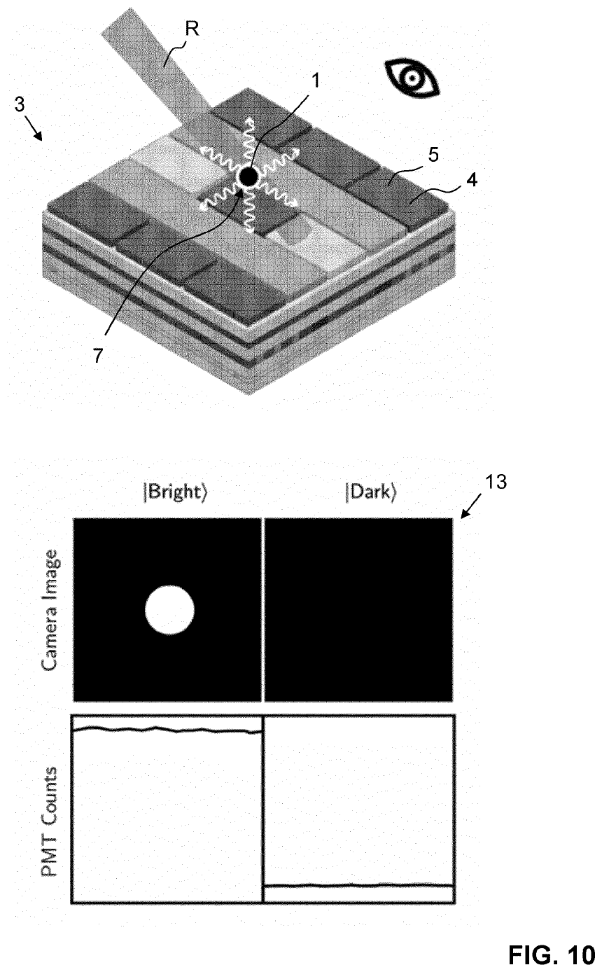

This is illustrated in FIG. 10, wherein a state-dependent detection is shown as an example for discrimination between two internal states of a charged particle 1. To this end, laser radiation R tuned close in frequency to an appropriate transition is shone upon the charged particle 1. The fluorescence is collected via a detection device in the form of an imaging system and allows for discrimination between the two states based on the number of photon counts, for example.

Hence, from FIGS. 3 to 10 it becomes apparent that the method according to the invention enables a trapping and reconfiguration of charged particles, wherein the charged particles are reconfigured to perform a quantum operation or an electric field sensing, respectively.

A possible sequence of steps in order to perform a quantum operation preferably is as follows:
0. Load a single charged particle into individual trapping sites of one or more trapping unit cells (i.e. one charged particle per trapping site) OR load two or more charged particles into one or more trapping sites of one or more trapping unit cells
1. Cool the charged particles
2. Initialize quantum information states
3. Perform a quantum logic gate operation (via laser(s) and/or microwave)
4. Reconfigure positions of charged particles
5. Perform another quantum logic gate operation (via laser(s) and/or microwave)
6. Reconfigure positions of charged particles
7. Read out quantum information states for instance by detecting a subset of charged particles.

Steps 2 through 7 are preferably repeated a plurality of times so as to perform a quantum computation.

A possible sequence of steps in order to perform an electric field sensing preferably is as follows:
0. Load at least one charged particle into a single trapping site of a single trapping unit cell
1. Cool the charged particle
2. Initialize the quantum information state
3. Reconfigure position of charged particle
4. Interaction of the charged particle with the noise source
5. Readout of the potentially altered quantum information states.

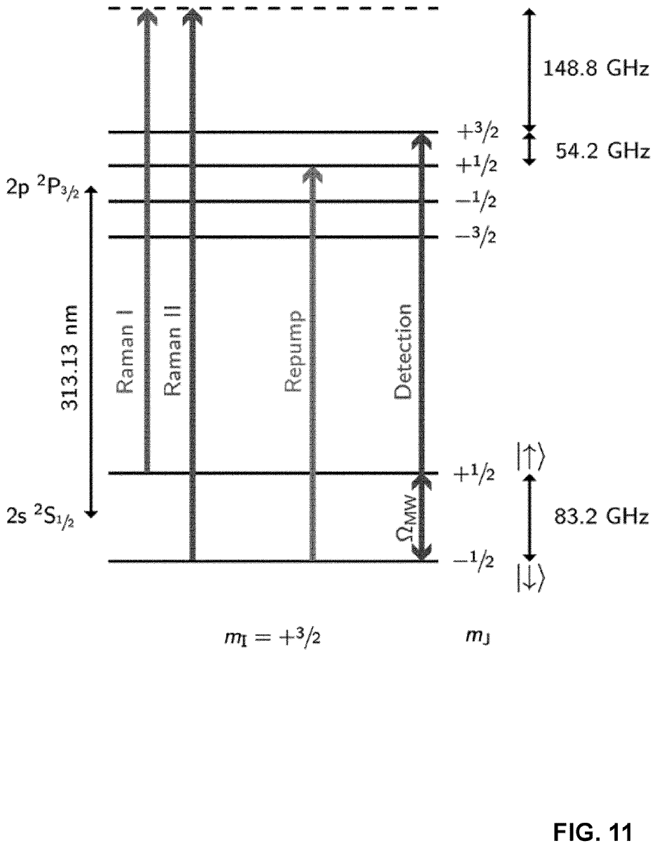

The above steps are now illustrated in greater detail with respect to FIGS. 11 to 19b.

FIG. 11 depicts a level scheme of a ⁹Be⁺ ion in a magnetic field of 3 T. The qubit states up and down are encoded in the Zeeman sublevels of the S_{1/2} ground state manifold. To detect the qubit state, detection light at 313.13 nm is applied. If the ion is in the +½ state of the S_{1/2} manifold, the ion is excited to the P_{3/2}, m_{J}=+3/2 state and decays back to the up state, thereby emitting a photon. By repeating this process many times, the resulting photon flux can be detected using a CCD camera or photomultiplier tube. If the ion is in the down state, the detection laser has no effect.

By scattering photons off the same S_{1/2}, m_{J}=+½<->P_{3/2}, m_{J}=+3/2, transition, the motional state of the ion can be cooled using Doppler cooling.

The ion can be prepared with high fidelity in the up state. If the ion is in the down state, it can be excited to the P_{3/2}, m_{J}=+½ state using the repump laser. With some probability it will then decay to the up state. Over time, it will be optically pumped to the up state with a probability near unity. The ion can be transferred between the qubit states coherently by driving a Raman transition. Two lasers phase locked to a difference frequency of 83.2 GHZ and tuned 148.8 GHz blue of the uppermost P_{3/2} are applied for this purpose.

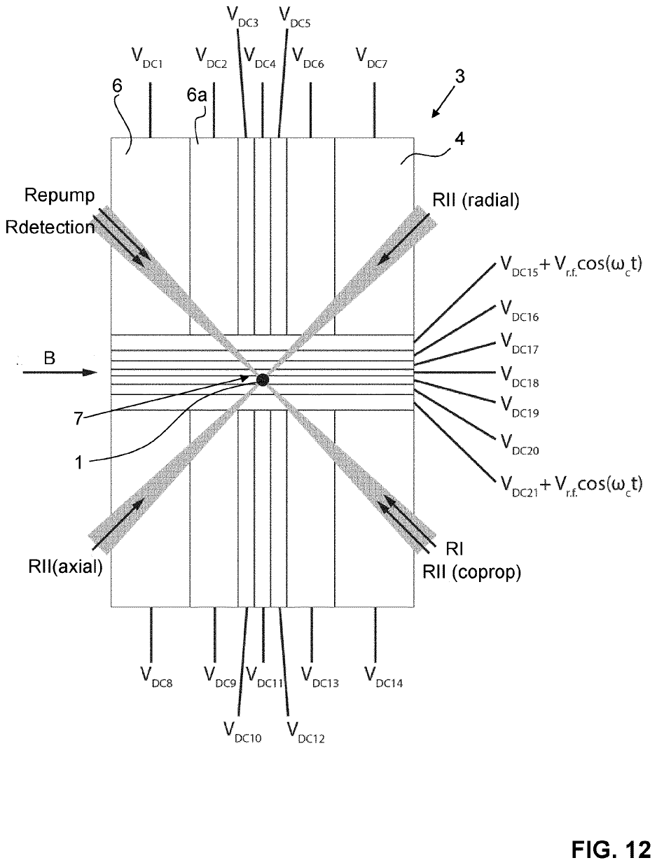

FIG. 12 depicts a top view of a trapping unit cell 3 in an initial state. DC voltages (V_{DC1}−V_{DC21}) are applied to 21 trapping electrodes 6, 6a, . . . to generate static trapping potentials 35-152 micrometers above the trapping surface 5 of the trapping unit cell 3. To couple the magnetron and cyclotron motional modes, a weak axialization r.f. voltage V_{r.f.}<32 mV is applied to two electrodes 6, 6a, . . . at a frequency of 5.11 MHz. Laser light is delivered in free-space with the propagation direction parallel to the trapping surface.

Three Raman beam geometries are possible:
Raman I+Raman II (coprop), where the differential k-vector of the two beams is close to 0 and the qubit coupling is not sensitive to the ion motion;
Raman I+Raman II (axial), where the differential k-vector is aligned along the magnetic field axis and the qubit coupling is sensitive to the axial ion motion;
Raman I+Raman II (radial), where the differential k-vector is aligned perpendicular to the magnetic field axis and the qubit coupling is sensitive to the radial ion motion.

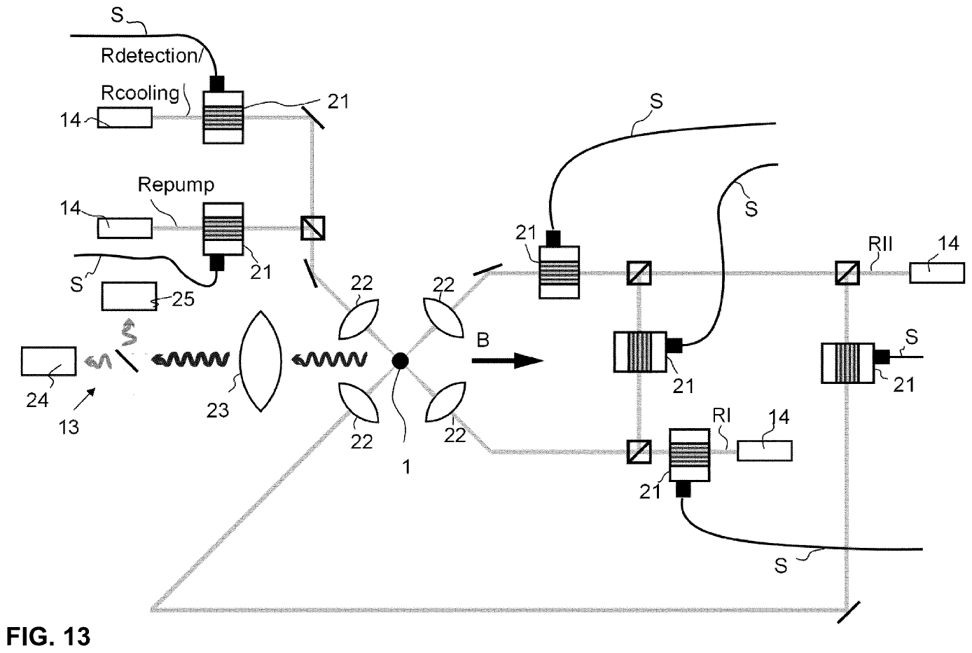

FIG. 13 is a schematic sketch of a trapping apparatus 2 for performing the method according to the invention. Four laser beams from four lasers 14 with a wavelength close to 313 nm are used for cooling (Rcooling), optical pumping (Repump), quantum state manipulation (RI, RII) and detection (RDetection) of one or two trapped Be ions 1. The intensity and frequency of all the laser beams are set by applying r.f. voltages indicated by the reference numeral S to acousto-optic modulators (AOM) 21. An electronic control system with arbitrary waveform generators (not shown) creates the sequence of r.f. voltage pulses. The beams are focused onto the ion using lenses 22 and an imaging objective 23 collects the fluorescence light emitted by the ion 1 for state detection and images it onto a detection device 13 in the form of a CCD camera 24 and a photomultiplier tube (PMT) 25.

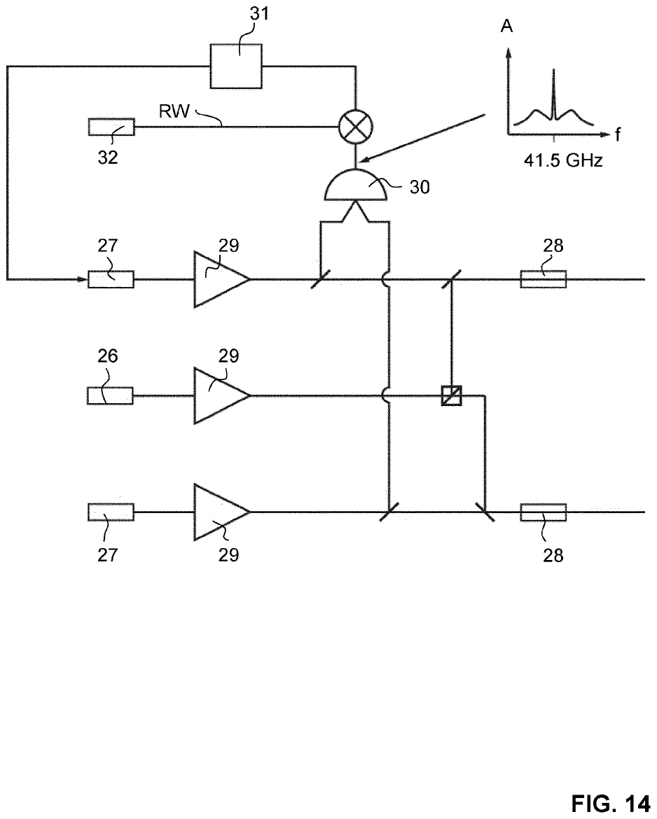

FIG. 14 illustrates the phase locking of the Raman lasers 14. To this end light at 313 nm is generated in two steps: first light at 626 nm is created from amplified external cavity diode lasers (ECDL) 26 and 27 at 1050 nm and 1550 nm, respectively, by sum-frequency generation in a PPLN crystal 28. Amplification of the radiation occurs in fiber amplifiers 29. 626 nm light is subsequently converted to 313 nm by cavity-enhanced frequency doubling.

To obtain two Raman laser sources with a frequency difference of 83 GHZ, a small amount of 1550 nm light is picked off after the fiber amplifiers 29 and mixed on a photodiode 30 with a bandwidth of 50 GHz. At 1550 nm, the target frequency difference is 41.5 GHZ. The resulting electrical signal is further mixed with a reference wave RW at 41.5 GHz resulting from an r.f. generator 32. The resulting error signal is fed to a PID controller 31 and the feedback loop is closed by modulating the current of one of the source diode lasers. The resulting linewidth is <10 Hz with a feedback loop bandwidth of about 500 KHz.

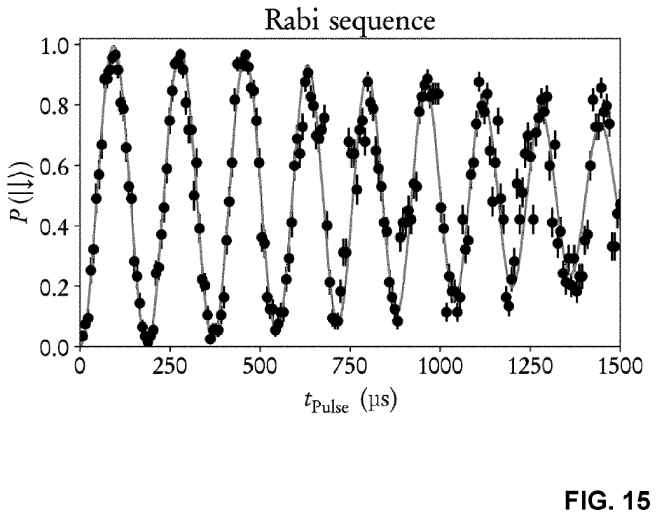

FIG. 15 depicts a graph with experimental data depicting the probability to find the ion in the up state after applying the copropagating Raman beams for a time t_{Pulse}. This demonstrates the capability of executing single-qubit quantum gates.

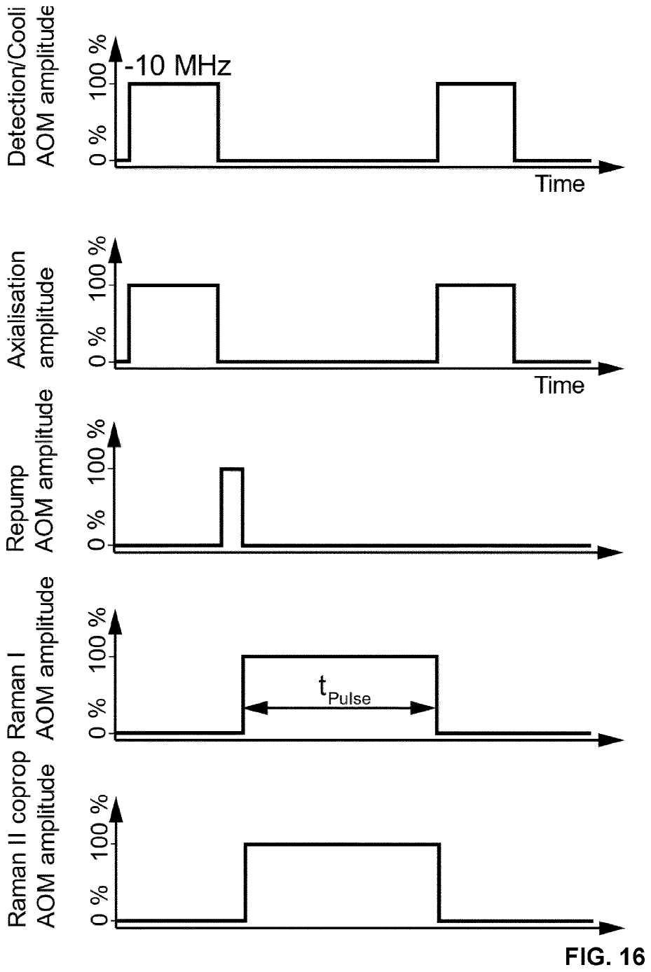

FIG. 16 depicts the pulse sequence that was applied to obtain the Rabi flop data depicted in FIG. 15. The first detection/cooling pulse performs Doppler cooling with a laser beam detuned by −10 MHz from the S_{1/2}, m_{J}=+½<->P_{3/2}, m_{J}=+3/2 transition. While the detection/cooling beam is on, the axialization voltage is applied to the axialization electrodes. After cooling, the qubit is optically pumped to the up state using the repump laser. After that, the copropagating Raman lasers are applied for a pulse time t_{Pulse}. The second detection/cooling pulse is performed on resonance and is used to detect the qubit state.

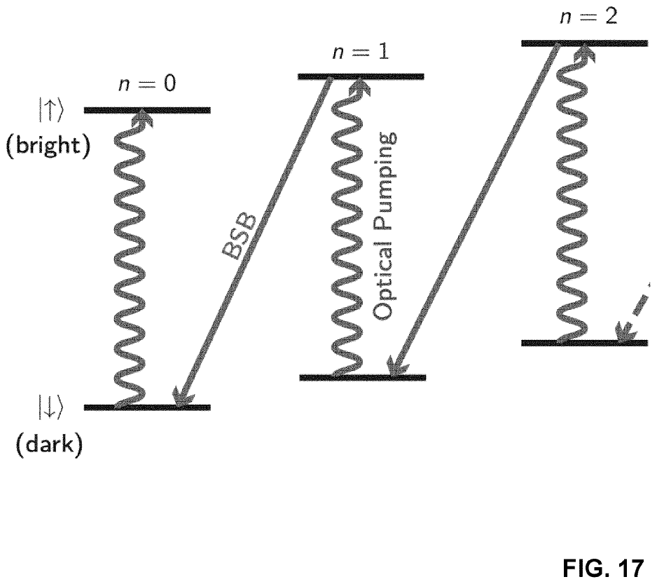

FIG. 17 schematically illustrates the sideband cooling principle. That is, Doppler cooling leaves the ion motional in a thermal state with non-zero mean occupation. To cool the ion to or near to the ground state, sideband cooling can be applied. In this case a repump laser optically pumps the qubit state from down to up, which is indicated by the squiggly arrows. By detuning the Raman laser drive by the motional frequency (a blue sideband, BSB), an |up, n>->|down, n−1> transition can be made, which is indicated by the solid arrows. The picture depicts a sequence of repeated optical pumping and BSB drives, which ends with the ion motional state reaching the ground state n=0.

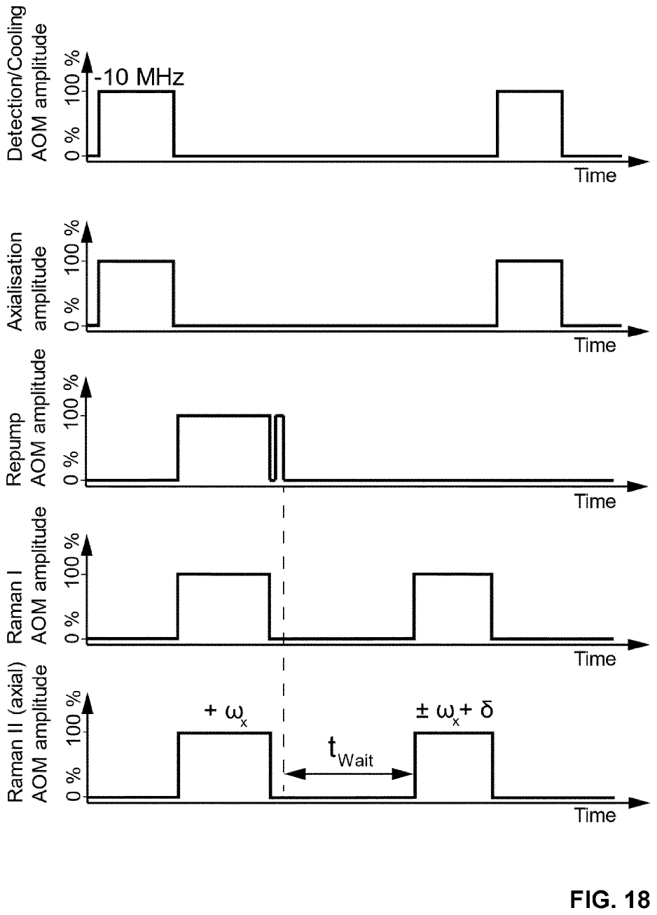

FIG. 18 depicts a conceivable pulse sequence for sideband cooling and thermometry of the axial mode of the ion. In particular, Doppler cooling is performed by the first pulse on the detection/cooling AOM. Sideband cooling of the axial mode is subsequently applied by using the (Raman I, Raman II axial) beam pair, with the Raman II (axial) frequency detuned by the motional frequency of the axial mode ωₓ. The repump laser is on simultaneously. After the sideband cooling pulse and a short repump laser pulse, the qubit is left in the up state. After a wait time t_{Wait}, a Raman pulse drives the qubit transition at frequency detuning +ωₓ+δ, corresponding to the |up, n> <->|down, n−1> transition detuned by δ, or at frequency detuning −ωₓ+δ, corresponding to the |up, n> <->|down, n+1> transition detuned by δ. The last pulse on the detection/cooling AOM detects the qubit state.

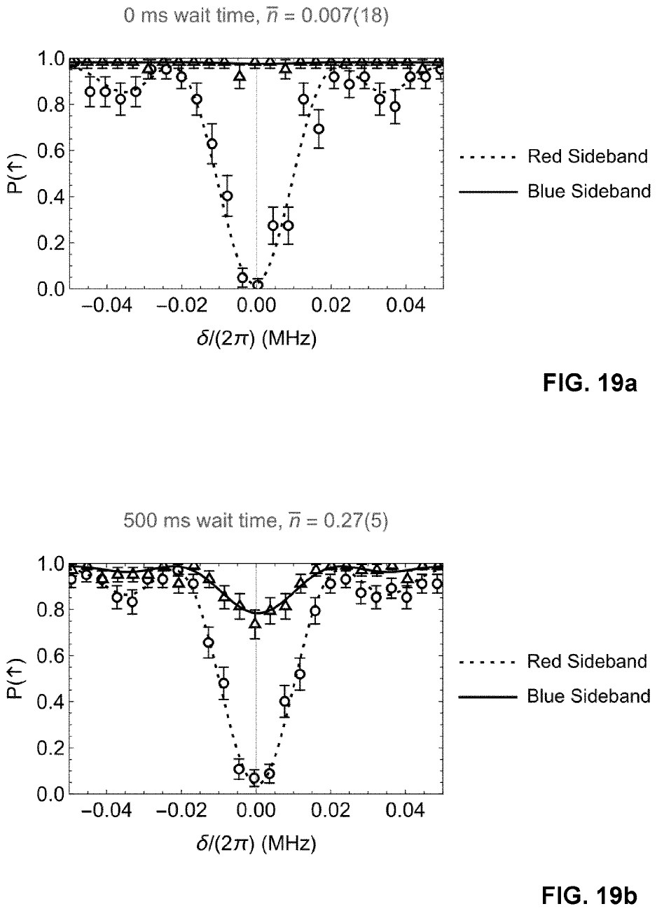

FIGS. 19a and 19b depict the heating rates being taken using the pulse sequence disclosed in FIG. 18 and of ion trapped at 152 micrometers above the trapping surface and with an axial mode frequency of 1.9 MHz. In FIG. 19a, no wait time is applied between the end of the state preparation and probing the sidebands. The blue (+) sideband cannot be excited, while the qubit state can be flipped from up to down using the red sideband, indicating that the ion motional state is near to the ground state (n̅=0.007).

In FIG. 19b, a wait time of 500 milliseconds is applied between the end of the state preparation and probing the sidebands. The blue sideband transition can be excited less than the red sideband transition, indicating that the motional state is still near to the ground state. The ratio of the sideband strengths indicates a thermal state with mean n̅=0.27. This indicates a heating rate of 0.54 phonons per second, which to our knowledge is the lowest ever measured at an electrode-ion distance equal or lower to this trap.

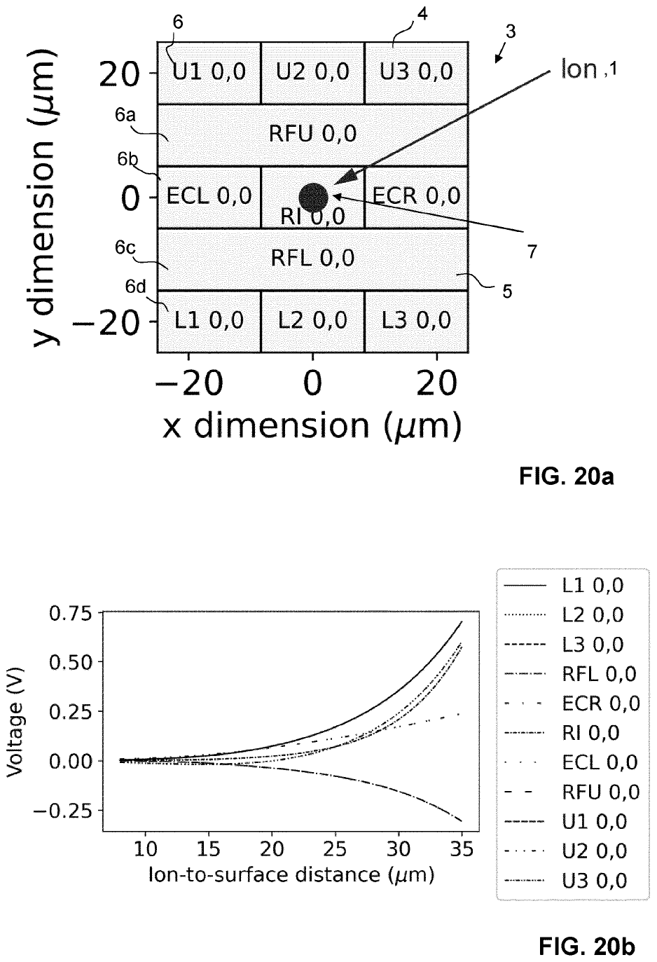

FIGS. 20a to 22e are examples that illustrate the individual reconfiguration of the trapping sites in order to move or transport one or two charged particles in three dimensions.

An out-of-plane transport of a charged particle is illustrated with reference to FIGS. 20a and 20b. In particular, FIG. 20a depicts a top view of a trapping unit cell that comprises eleven electrodes 6, 6a, . . . . A total size of the trapping unit cell is 50 micrometers×50 micrometers. A charged particle 1 in the form of an ion is trapped on a trapping site 7 of the trapping control layer 4 of the trapping unit cell 3. FIG. 20b depicts a diagram with voltages that can be applied to the electrodes 6, 6a, . . . of the trapping unit cell 3 of FIG. 20a in order to move the trapping site 7 with an axial frequency of 2 MHz (for a ⁹Be⁺ ion) between (x=0 micrometer, y=0 micrometer, z=8 micrometer) to (x=0 micrometers, y=0 micrometers, z=35 micrometers) or vice versa, with z being the direction perpendicular to the trapping surface 5.

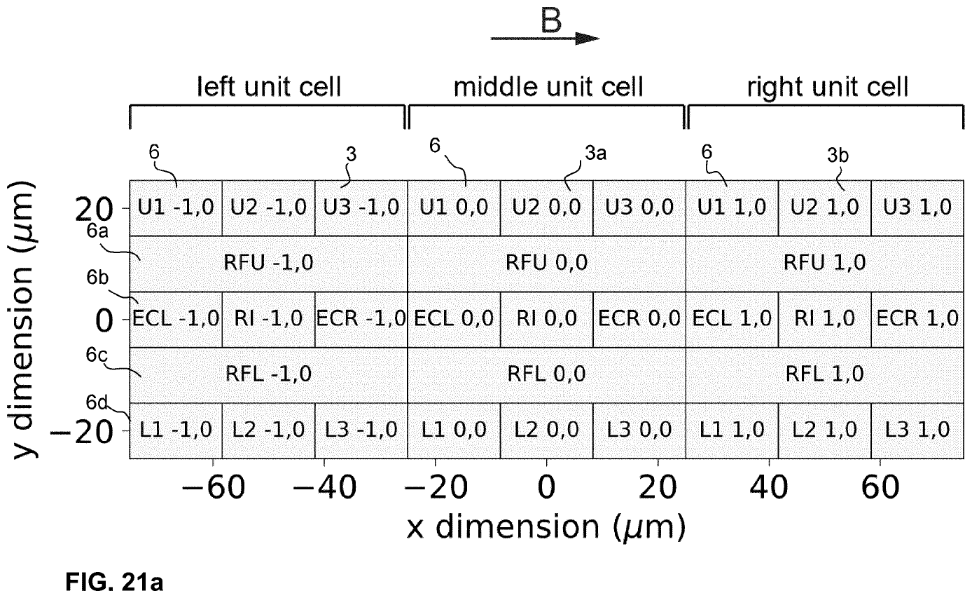

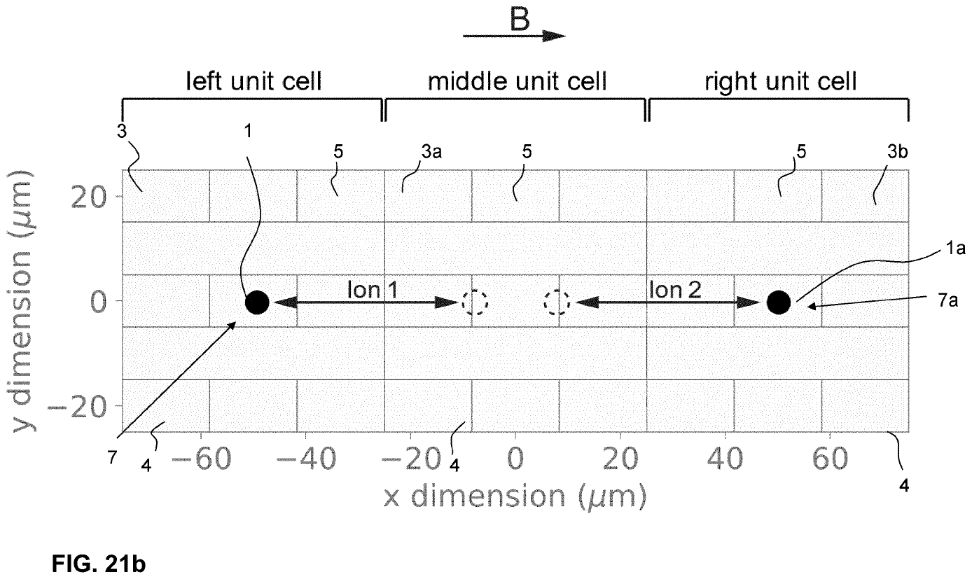

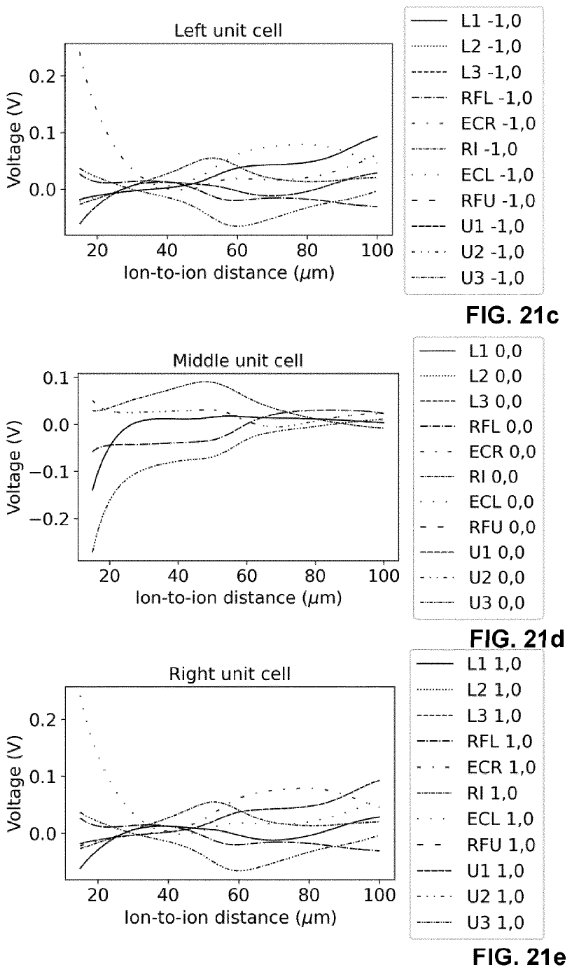

A transport of a charged particle parallel to the trapping surface is illustrated with reference to FIGS. 21a to 21e. In particular, FIG. 21a depicts a top view of an array comprising three trapping unit cells 3, 3a, 3b of a same structure and being arranged along the magnetic field B. Each trapping unit cell 3, 3a, 3b has a size of 50 micrometers×50 micrometers and comprises eleven electrodes, for a total of 33 electrodes. As previously, only some of the electrodes 6, 6a, . . . are provided with reference signs for the sake of clarity. FIG. 21b illustrates that one charged particle 1, 1a, also denoted as ions 1 and 2, may be trapped on a trapping site 7 and 7a above the left and the right trapping unit cell 3 and 3b, respectively. By applying suitable time-varying voltages, the two trapping sites 7, 7a can be brought close together above the middle trapping unit cell 3a. The reverse process is also possible. The charged particle 1 is moved between positions (x=−75 micrometers, y=0 micrometers, z=20 micrometers) and (x=−7.5 micrometers, y=0 micrometers, z=20 micrometers). The charged particle 1a (also called ion 2 in the figure) is moved between positions (x=75 micrometers, y=0 micrometers, z=20 micrometers) and (x=7.5 micrometers, y=0 micrometers, z=20 micrometers). The z-direction denotes the distance between the charged particles 1, 1a and the trapping surface 5. FIG. 21c depicts a diagram with voltages that can be applied to the electrodes 6, 6a, . . . of the left trapping unit cell 3 of FIG. 21a in order to move the execute the process described with reference to FIG. 21b. FIG. 21d depicts a diagram with voltages that can be applied to the electrodes 6, 6a, . . . of the middle trapping unit cell 3a of FIG. 21a in order to move the execute the process described with reference to FIG. 21b. FIG. 21e depicts a diagram with voltages that can be applied to the electrodes 6, 6a, . . . of the right trapping unit cell 3b of FIG. 21a in order to move the execute the process described with reference to FIG. 21b.

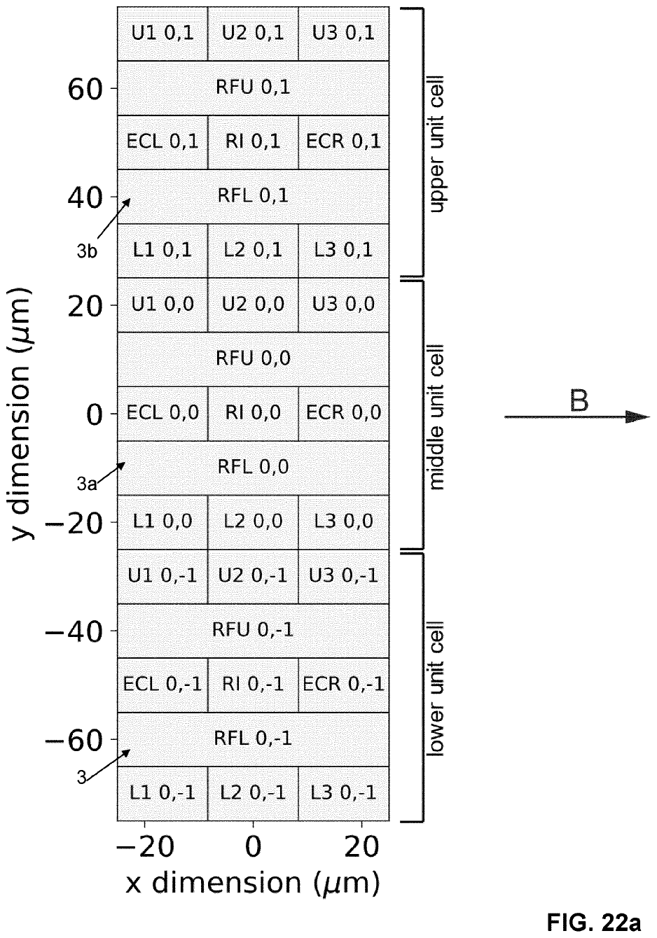

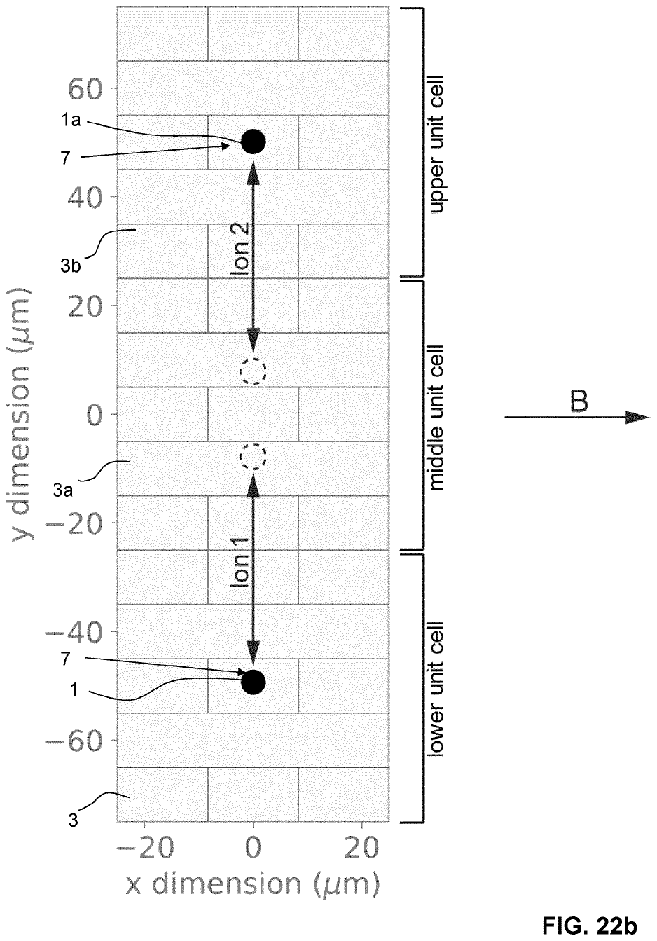

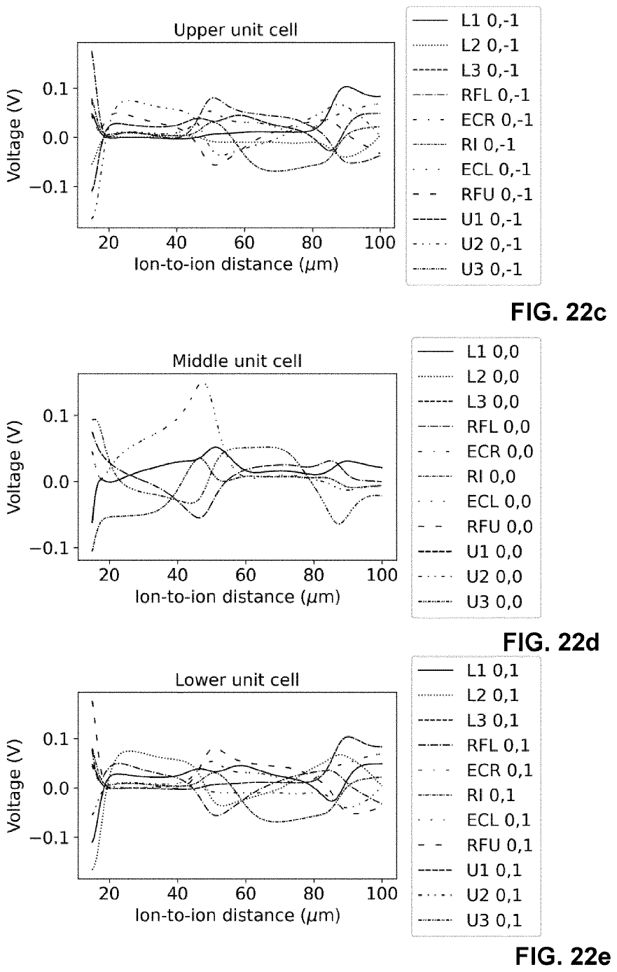

FIGS. 22a to 22e illustrate another transport of a charged particle parallel to the trapping surface. In particular, FIG. 22a depicts an array of three trapping unit cells 3, 3a, 3b of a same structure and being arranged perpendicular to the magnetic field B. Each trapping unit cell has a size of 50 micrometers×50 micrometers and eleven electrodes for a total of 33 electrodes. FIG. 22b illustrates that two charged particles 1, 1a, also denoted as ion 1 and ion 2, may be trapped on a trapping site 7, 7a above the trapping surface 5 of the upper trapping unit cell 3 and the lower trapping unit cell 3b, respectively. By applying suitable time-varying voltages, the two trapping sites 7, 7a can be brought close together above the middle trapping unit cell 3a. The reverse process is also possible.

The charged particle 1, also denoted as ion 1, is moved between positions (x=0 micrometers, y=−50 micrometers, z=20 micrometers) and (x=0 micrometers, y=−7.5 micrometers, z=20 micrometers). The charged particle 1a, also denoted as ion 2, is moved between positions (x=0 micrometers, y=50 micrometers, z=20 micrometers) and (x=0 micrometers, y=7.5 micrometers, z=20 micrometers). The z-direction denotes the distance between the charged particles 1, 1a and the trapping surface 5. FIG. 22c depicts a diagram with voltages that can be applied to the electrodes of the upper trapping unit cell 3 of FIG. 22a in order to move the execute the process described with reference to FIG. 22b. FIG. 22d depicts a diagram with voltages that can be applied to the electrodes of the middle trapping unit cell 3a of FIG. 22a in order to move the execute the process described with reference to FIG. 22b. FIG. 22e depicts a diagram with voltages that can be applied to the electrodes 6of the lower trapping unit cell 3b of FIG. 22a in order to move the execute the process described with reference to FIG. 22b.

LIST OF REFERENCE SIGNS

| | |
|---|---|
| 1, 1a | charged particle |
| 2 | trapping apparatus |
| 3, 3a | trapping unit cell |
| 4 | trapping control layer |
| 5 | trapping surface |
| 6, 6a | electrodes |
| 7, 7a | trapping site |
| 8 | current-carrying conductor |
| 9 | microwave control layer |
| 10 | optical control layer |
| 11 | wave guide |
| 12 | grating coupler |
| 13 | detection device |
| 14 | source of electromagnetic radiation |
| 15 | interconnect layer |
| 16 | electrically conducting track |
| 17 | ground plane layer |
| 18 | substrate layer |
| 19 | transparent area |
| 20 | transparent area |
| 21 | AOM |
| 22 | lens |
| 23 | imaging objective |
| 24 | CCD camera |
| 25 | PMT |
| 26 | ECDL |
| 27 | ECDL |
| 28 | PPLN crystal |
| 29 | fiber amplifier |
| 30 | photodiode |
| 31 | PID controller |
| 32 | r.f. generator |
| E | extension direction |
| A | axial direction |
| B | magnetic field |
| x | spatial direction |
| y | spatial direction |
| z | spatial direction |
| R | electromagnetic radiation |
| S | signal |
| I_{MW} | oscillating current |
| RW | reference wave |

1. A method of trapping and reconfiguring at least one charged particle in a trapping apparatus,
wherein the trapping apparatus comprises:
at least one trapping unit cell defining an extension direction; and
at least one magnet that is configured to generate a magnetic field,
wherein the trapping unit cell comprises at least one trapping control layer, and
wherein the trapping control layer defines a trapping surface and comprises at least two electrodes,
wherein the method comprises the steps of:
trapping at least one charged particle in the trapping apparatus by generating a magnetic field with the magnet and by generating a static electric potential with the electrodes by applying static voltages to said electrodes, whereby the at least one charged particle is trapped on a trapping site being generated above the trapping surface of the trapping control layer and exhibits motional modes, one of the motional modes being the magnetron motional mode,
wherein the method further comprises the steps of:
cooling the motional modes of the at least one charged particle by coupling its magnetron motional mode to at least one of the other motional modes, and
reconfiguring a spatial position of the trapping site by applying a time-varying voltage to the electrodes, whereby the at least one charged particle is moved along at least one spatial direction.

2. The method according to claim 1, wherein the trapping control layer comprises a plurality of electrodes and wherein a plurality of trapping sites are generated, and
wherein the spatial positions of the plurality of trapping sites are independently reconfigured by applying the time-varying voltages to the plurality of electrodes.

3. The method according to claim 1, wherein the charged particle is cooled at a plurality of trapping sites by coupling its magnetron motional mode to at least one of the other motional modes.

4. The method according to claim 1, wherein at least two charged particles are trapped on at least two trapping sites, and wherein at least one of:
i) the reconfiguration of the spatial positions of the at least two trapping sites comprises at least one of an axial merging, axial splitting, a radial merging, or radial splitting of the at least two trapping sites, or
ii) the charged particles are simultaneously cooled at each trapping sites by coupling their magnetron motional modes to at least one of their other modes.

5. The method according to claim 1, wherein at least one of:
i) the trapping unit cell comprises at least one current-carrying conductor and wherein the method comprises the step of controlling the charged particle by supplying a static or oscillating current to the current-carrying conductor in order to create a static magnetic field gradient in the magnetic field or an oscillating magnetic field gradient in the magnetic field, or
ii) the method comprises the step of controlling the charged particle by irradiating electromagnetic radiation onto the charged particle.

6. The method according to claim 5, wherein at least one of:
i) the current-carrying conductor is provided in the trapping control layer, or
ii) the trapping unit cell comprises at least one microwave control layer, the current-carrying conductor being provided in the microwave control layer.

7. The method according to claim 1, wherein the trapping unit cell comprises at least one optical control layer being configured to direct electromagnetic radiation towards the charged particle, and
wherein the method comprises the step of optically controlling the charged particle by irradiating electromagnetic radiation onto the charged particle via the optical control layer.

8. The method according to claim 7, wherein the optical control layer comprises at least one waveguide being configured to guide electromagnetic radiation and at least one grating coupler being configured to couple electromagnetic radiation into or out of the waveguide.

9. The method according to claim 1, wherein the trapping apparatus comprises at least one detection device, and
wherein the method comprises the step of detecting at least one of a presence or absence of the charged particle, at least one internal state of the charged particle, or at least one external state of the charged particle with the detection device.

10. The method according to claim 1, wherein the trapping apparatus comprises at least one source of electromagnetic radiation such as a laser, and wherein the method comprises the step of irradiating electromagnetic radiation in order to at least one of:
ionize at least one particle in order to generate the charged particle,
cool the charged particle, such as to reduce a motional amplitude of at least one motional mode of the charged particle, or
prepare the charged particle in a desired quantum state, such as at least one of an internal state of the charged particle or an external state of the charged particle.

11. The method according to claim 1, wherein the trapping unit cell comprises at least one of:
at least one interconnect layer comprising at least one electrically conducting track that is in connection with the electrodes,
at least one ground plane layer being held at electrical ground and being configured to electrically shield the electrodes, or
at least one substrate layer being configured to electrically isolate the trapping control layer from other conducting layers.

12. The method according to claim 1, wherein the trapping apparatus comprises at least one of:
at least one source for generating particles or charged particles, or
at least one vacuum chamber, wherein the trapping unit cell is received in the vacuum chamber.

13. The method according to claim 1, wherein the trapping apparatus is configured as a quantum information processor, and
wherein the charged particle being trapped in the trapping apparatus is reconfigured to perform at least one quantum operation such as quantum computation, and
wherein the quantum operation is performed by:
(1) trapping at least one charged particle on at least one trapping site by applying the magnetic field and the static voltages to the electrodes,
(2) cooling the charged particle,
(3) performing a quantum information state initialization by controlling the charged particle, whereby the charged particle is initialized,
(4) reconfiguring a spatial position of the at least one trapping site by applying the time-varying voltages to the electrodes, whereby the initialized charged particle is moved along at least one spatial direction to a desired location above the trapping surface of the trapping control layer,
(5) performing at least one quantum logic gate operation, and
(6) performing a quantum state readout.

14. The method according to claim 13, wherein at least one of:
i) at least two charged particles are trapped on at least two trapping sites, and wherein the reconfiguration of the spatial positions of the at least two trapping sites comprises at least one of an axial merging, axial splitting, a radial merging or radial splitting of the at least two trapping sites, or
ii) several quantum logic gate operations are performed, and wherein a spatial position of the trapping site is reconfigured after one or more quantum logic gate operations.

15. The method according to claim 1, wherein the trapping apparatus is configured as an electric field sensor, and
wherein the charged particle being trapped in the trapping apparatus is reconfigured to perform electric field sensing, and
wherein the electric field sensing is performed by:
probing a sample surface by measuring the electric field noise experienced by the charged particle due to the presence of the sample surface.

16. The method according to claim 15, wherein the measuring of the electric field noise comprises the steps of:
(1) trapping at least one charged particle on at least one trapping site by applying the magnetic field and the electrical voltage to the electrodes,
(2) cooling the charged particle,
(3) performing a quantum information state initialization by controlling the charged particle, whereby the charged particle is initialized,
(4) reconfiguring a spatial position of the at least one trapping site by applying the time-varying voltages to the electrodes, whereby the initialized charged particle is moved along at least one spatial direction to a desired location above the trapping surface of the trapping control layer,
(5) allowing the charged particle to interact with a noise source affecting an internal or external state of the charged particle,
(6) performing at least one quantum logic gate operation, and
(7) performing a quantum state readout.

17. The method according to claim 1, wherein the motional modes of the at least one charged particle are cooled by applying an axialization voltage to at least one electrode of the trapping control layer, while simultaneously irradiating electromagnetic radiation onto the charged particle.

18. The method according to claim 3, wherein the charged particle is cooled at a plurality of trapping sites by applying a plurality of axialization voltages to a plurality of electrodes of the trapping control layer, while simultaneously irradiating electromagnetic radiation onto the charged particle.

19. The method according to claim 4, wherein the charged particles are simultaneously cooled at each trapping sites by applying axialization voltages independently to the electrodes of the trapping control layer, while simultaneously irradiating electromagnetic radiation onto the charged particles at least one of before or after the reconfiguration of the spatial positions of the trapping sites.

20. The method according to claim 8, wherein said waveguide and grating coupler are configured to at least one of i) route electromagnetic radiation from a source of electromagnetic radiation towards the charged particle or ii) collect and route electromagnetic radiation being emitted from the charged particle towards a detection device.

21. The method according to claim 9, wherein the at least one of a presence or absence of the charged particle, at least one internal state of the charged particle, or at least one external state of the charged particle are detected with the detection device by detecting electromagnetic radiation being emitted from the charged particle.

22. The method according to claim 10, wherein cool the charged particle is cooled to or near the motional ground state.

23. The method according to claim 13, wherein at least one of:
the charged particle is cooled by irradiating electromagnetic radiation onto the charged particle and by applying an axialization voltage to the electrodes,
the quantum information state initialization is performed by controlling the charged particle by irradiating electromagnetic radiation onto the charged particle,
the at least one quantum logic gate operation is performed by irradiating the charged particle with electromagnetic radiation, or
the quantum state readout is performed by detecting at least one of the presence or absence of the charged particle, at least one internal state of the charged particle, or at least one external state of the charged particle with the detection device.

24. The method according to claim 16, wherein at least one of:
the charged particle is cooled by irradiating electromagnetic radiation onto the charged particle and by applying an axialization voltage to the electrodes,
the quantum information state initialization is performed by irradiating electromagnetic radiation onto the charged particle,
the at least one quantum logic gate operation is performed by irradiating the charged particle with electromagnetic radiation, or
the quantum state readout is performed by detecting at least one of the presence or absence of the charged particle, at least one internal state, or at least one external state of the charged particle with the detection device.
